(19) United States
(12) Patent Application Publication
(10) Pub. No.: US 2025/0135348 A1
(43) Pub. Date: May 1, 2025

(54) INTERACTION METHOD AND APPARATUS BASED ON FLYABLE PROP

(71) Applicant: Tencent Technology (Shenzhen) Company Limited, Shenzhen (CN)

(72) Inventors: Wei QUAN, Shenzhen (CN); Wei FAN, Shenzhen (CN)

(73) Assignee: Tencent Technology (Shenzhen) Company Limited, Shenzhen, GD (CN)

(21) Appl. No.: 19/004,141

(22) Filed: Dec. 27, 2024

Related U.S. Application Data
(63) Continuation of application No. PCT/CN2023/126282, filed on Oct. 24, 2023.

(30) Foreign Application Priority Data
Dec. 12, 2022 (CN) 202211610140.1

(51) Int. Cl. A63F 13/57

(52) U.S. Cl. CPC A63F 13/57

(57) ABSTRACT

In an interaction method, a first flyable prop is generated in a virtual scene when a first cast operation is triggered by a first virtual object. The first flyable prop is associated with a virtual skill and the first virtual object is associated with a first camp. The first flyable prop that is controlled to move along a first flight trajectory is displayed. The first flight trajectory is determined based on the first cast operation. The first flyable prop is controlled to move along a second flight trajectory when a second flyable prop is detected within a target range of the first flyable prop. The second flyable prop is generated based on a second cast operation performed by a second virtual object. The second virtual object is associated with a second camp. The second flight trajectory is different from the first flight trajectory.

### RELATED APPLICATIONS

The present application is a continuation of International Application No. PCT/CN2023/126282, filed on Oct. 24, 2023, which claims priority to Chinese Patent Application No. 202211610140.1, entitled “INTERACTION METHOD AND APPARATUS BASED ON FLYABLE PROP, ELECTRONIC DEVICE, AND STORAGE MEDIUM” and filed on Dec. 12, 2022. The entire disclosures of the prior applications are hereby incorporated by reference.

### FIELD OF THE TECHNOLOGY

This disclosure relates to the field of computer technologies, including to an interaction method and apparatus based on a flyable prop, an electronic device, and a storage medium.

### BACKGROUND OF THE DISCLOSURE

With the development of computer technologies and the diversification of terminal functions, multiplayer online battle arena (MOBA) games gradually become popular. In a virtual scene provided by a MOBA game, virtual objects belonging to the same team or different teams can collaborate or compete with each other by casting virtual skills to each other.

### SUMMARY

Embodiments of this disclosure provide an interaction method and apparatus based on a flyable prop, an electronic device, and a storage medium. The technical solutions are as follows:

According to an aspect, an interaction method is provided. The interaction method is based on a flyable prop. In the method, a first flyable prop is generated in a virtual scene when a first cast operation is triggered by a first virtual object. The first flyable prop is associated with a virtual skill and the first virtual object is associated with a first camp. The first flyable prop that is controlled to move along with a first flight trajectory is displayed. The first flight trajectory is determined based on the first cast operation. The first flyable prop is controlled to move along a second flight trajectory when a second flyable prop is detected within a target range of the first flyable prop. The second flyable prop is generated based on a second cast operation performed by a second virtual object. The second virtual object is associated with a second camp. The second flight trajectory is different from the first flight trajectory.

According to an aspect, an apparatus, such as an interaction apparatus based on a flyable prop, is provided. The apparatus includes processing circuitry that is configured to generate a first flyable prop in a virtual scene when a first cast operation is triggered by a first virtual object. The first flyable prop is associated with a virtual skill and the first virtual object is associated with a first camp. The processing circuitry is configured to display the first flyable prop that is controlled to move along a first flight trajectory. The first flight trajectory is determined based on the first cast operation. The processing circuitry is configured to control the first flyable prop to move along a second flight trajectory when a second flyable prop is detected within a target range of the first flyable prop. The second flyable prop is generated based on a second cast operation performed by a second virtual object. The second virtual object is associated with a second camp. The second flight trajectory is different from the first flight trajectory.

According to an aspect, an electronic device is provided. The electronic device includes one or more processors and one or more memories, the one or more memories have at least one computer program stored therein, and the at least one computer program is loaded and executed by the one or more processors to implement the foregoing interaction method based on a flyable prop.

According to an aspect, a non-transitory computer-readable storage medium is provided. The non-transitory computer-readable storage medium has at least one computer program stored therein, and the at least one computer program is loaded and executed by a processor to implement the foregoing interaction method based on a flyable prop.

According to an aspect, a computer program product is provided. The computer program product includes one or more computer programs, and the one or more computer programs are stored in a computer-readable storage medium. One or more processors of an electronic device can read the one or more computer programs from the computer-readable storage medium, and the one or more processors execute the one or more computer programs to enable the electronic device to perform the foregoing interaction method based on a flyable prop.

Technical solutions provided in embodiments of this disclosure can include at least the following beneficial effects:

When the second flyable prop is detected within the target range of the first flyable prop, since camps of the first flyable prop and the second flyable prop are different, the first flyable prop is controlled to switch from the first flight trajectory to the second flight trajectory. This makes the flight trajectory of the first flyable prop rich in changes as a game battle progresses, improves prop resource utilization of the first flyable prop, enriches interaction manners based on a flyable prop, and improves human-computer interaction efficiency.

### BRIEF DESCRIPTION OF THE DRAWINGS

FIG. 1 shows a virtual world of a typical MOBA game according to an embodiment of this disclosure.

FIG. 2 is a schematic diagram of a virtual world observed from a perspective of a blue party according to an embodiment of this disclosure.

FIG. 3 is a schematic diagram of a virtual world observed from a perspective of a red party according to an embodiment of this disclosure.

FIG. 4 is a schematic diagram of displaying a user interface (UI) on a terminal according to an embodiment of this disclosure.

FIG. 5 is a schematic diagram of displaying a UI on a terminal according to an embodiment of this disclosure.

FIG. 6 is a schematic diagram of a virtual world according to an embodiment of this disclosure.

FIG. 7 is a schematic diagram of a virtual world according to an embodiment of this disclosure.

FIG. 8 is a schematic diagram of a mirrored virtual world of another typical MOBA game according to an embodiment of this disclosure.

FIG. 9 is a schematic diagram of a mirrored virtual world of another typical MOBA game according to an embodiment of this disclosure.

FIG. 10 is a schematic diagram of a mirrored virtual world of another typical MOBA game according to an embodiment of this disclosure.

FIG. 11 is a schematic diagram of an implementation environment of an interaction method based on a flyable prop according to an embodiment of this disclosure.

FIG. 12 is a flowchart of an interaction method based on a flyable prop according to an embodiment of this disclosure.

FIG. 13 is a schematic diagram of a ray trajectory of a single first flyable prop according to an embodiment of this disclosure.

FIG. 14 is a schematic diagram of ray trajectories of a plurality of first flyable props according to an embodiment of this disclosure.

FIG. 15 is a schematic diagram of an annular trajectory of a single first flyable prop according to an embodiment of this disclosure.

FIG. 16 is a schematic diagram of annular trajectories of a plurality of first flyable props according to an embodiment of this disclosure.

FIG. 17 is a flowchart of an interaction method based on a flyable prop according to an embodiment of this disclosure.

FIG. 18 is a diagram of a principle of a collision detection manner according to an embodiment of this disclosure.

FIG. 19 is a diagram of a principle of screening a second flyable prop according to an embodiment of this disclosure.

FIG. 20 is a schematic diagram of a blueprint tool according to an embodiment of this disclosure.

FIG. 21 is a schematic diagram of a principle of an interaction method based on a flyable prop according to an embodiment of this disclosure.

FIG. 22 is a schematic diagram of a structure of an interaction apparatus based on a flyable prop according to an embodiment of this disclosure.

FIG. 23 is a schematic diagram of a structure of a terminal according to an embodiment of this disclosure.

FIG. 24 is a schematic diagram of a structure of an electronic device according to an embodiment of this disclosure.

### DETAILED DESCRIPTION

To make objectives, technical solutions, and advantages of this disclosure clearer, the following further describes in detail implementations of this disclosure with reference to the accompanying drawings.

The terms “first”, “second”, and the like in this disclosure are used for distinguishing between same items or similar items of which effects and functions are basically the same. The “first”, “second”, and “nth” do not have a dependency relationship in logic or time sequence, and a quantity and an execution order thereof are not limited.

In this disclosure, the use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The user-related information (including but not limited to the user's device information, personal information, behavior information, etc.), data (including but not limited to data used for analysis, stored data, displayed data, etc.), and signals involved in this disclosure, when applied to specific products or technologies in the manner of the embodiments of this disclosure, are all permitted, agreed, or authorized by the user or fully authorized by all parties, and the collection, use, and processing of relevant information, data, and signals shall comply with relevant laws, regulations, and standards of relevant countries and regions. For example, the user's operations or instructions involved in this disclosure are obtained with full authorization.

In the related art, there is a type of virtual skill. After a virtual object casts this type of virtual skill, a flyable prop that moves along a preset flight trajectory is created in a virtual scene. Since the flyable prop has a fixed flight trajectory and limited effective duration, the prop resource utilization of the flyable prop is low, the interaction manner based on the flyable prop is single, and the human-computer interaction efficiency is low. In an embodiment of this disclosure, an interaction method based on a flyable prop is provided, which can improve the prop resource utilization of a first flyable prop, enrich the interaction manner based on the flyable prop, and improve the human-computer interaction efficiency. Examples of terms involved in the embodiments of the disclosure are briefly introduced. The descriptions of the terms are provided as examples only and are not intended to limit the scope of the disclosure.

Virtual scene: It is a virtual scene displayed (or provided) by an application program when run on a terminal. The virtual scene may be a simulated environment of a real world, or may be a semi-simulated semi-fictional virtual environment, or may be a fictional virtual environment. The virtual scene may be any one of a two-dimensional virtual scene, a 2.5-dimensional virtual scene, or a three-dimensional virtual scene, and the dimension of the virtual scene is not limited in the embodiments of this disclosure. For example, the virtual scene may include the sky, the land, the ocean, or the like. The land may include environmental elements such as the desert and a city. The user may control the virtual object to move in the virtual scene. In one embodiment, the virtual scene may be further used for a virtual scene battle between at least two virtual objects, and there are virtual resources available to the at least two virtual objects in the virtual scene. In one embodiment, the virtual scene includes two symmetric regions, virtual objects on two different camps occupy the regions respectively, and a goal of each side is to destroy a target building/fort/base/crystal deep in the opponent's region to win victory. For example, the symmetric regions are a lower left corner region and an upper right corner region, or a middle left region and a middle right region.

Virtual object: It is a movable object in a virtual scene. The movable object may be a virtual character, a virtual animal, a virtual spirit, a cartoon character, or the like, for example, a character, an animal, a plant, an oil drum, a wall, or a stone displayed in a virtual scene. The virtual object may be a virtual image used for representing a user in the virtual scene. The virtual scene may include a plurality of virtual objects, and each virtual object has a shape and a volume in the virtual scene, and occupies some space in the virtual scene. In one embodiment, when the virtual scene is a three-dimensional virtual scene, the virtual object may be a three-dimensional model, the three-dimensional model may be a three-dimensional character constructed based on a three-dimensional human skeleton technology, and the same virtual object may show different appearances by wearing different skins. In some embodiments, the virtual objects may be alternatively implemented by using a 2.5-dimensional model or a two-dimensional model. This is not limited in the embodiments of this disclosure.

In one embodiment, the virtual object may be a player character controlled through an operation on a client, or may be a non-player character (NPC) set in virtual scene interaction. In one embodiment, the virtual object may be a virtual character for competition in a virtual scene. In one embodiment, a quantity of virtual objects participating in the interaction in the virtual scene may be preset, or may be dynamically determined according to a quantity of clients participating in the interaction.

Virtual skill: It refers to an inherent interactive skill that can be cast by a virtual object in the virtual environment. Usually, different virtual objects are bound with different exclusive virtual skills, but there are also some universal virtual skills that can be shared by different virtual objects. Users can choose which universal virtual skills to equip in this game. The universal virtual skills that have been equipped cannot be changed in the game, and there is an upper limit on the number of universal virtual skills that can be equipped in the game. The skill type of the virtual skill may include an attack skill, a defense skill, a treatment skill, an auxiliary skill, a reaping skill, and the like. Usually, after a virtual object casts a virtual skill, the virtual skill has a skill Cool Down (CD) period. The user cannot cast the virtual skill again during the skill CD period. The virtual skill will not return to a castable state until the skill CD ends. Different virtual skills can have identical or different skill CD lengths, and not every virtual skill has a skill CD. Virtual skills without a skill CD can be regarded as having a skill CD of 0.

Flyable prop: It refers to a flyable virtual prop generated, summoned, cast, or created by a virtual skill after the virtual object casts the virtual skill. The flyable prop can also be regarded as a summoned object of the virtual skill, or as a summoned object of the virtual object. Usually, the flyable prop generated by the virtual skill will move along the preset flight trajectory, such as moving along the ray trajectory starting from the virtual object and pointing to the direction of the joystick, until the flyable prop reaches the effective duration (or reaches the flight range, or collides with a virtual object of another camp to cause a certain virtual damage value).

Multiplayer Online Battle Arena (MOBA) game: It is a game in which several forts are provided in a virtual scene, and users on different camps control virtual objects to battle in the virtual scene, occupy forts or destroy forts of the opposing camp. For example, a MOBA game may divide users into at least two camps, and different teams on the at least two camps occupy respective map regions, and compete against each other using specific victory conditions as goals. The victory conditions include, but are not limited to at least one of occupying forts or destroy forts of the opposing camps, defeating virtual objects in the opposing camps, ensure own survivals in a specified scene and time, seizing a specific resource, and outscoring the opponent in interaction within a specified time. For example, in the MOBA game, the users may be divided into two camps. The virtual objects controlled by the users are scattered in the virtual scene to compete against each other, and the victory condition is to destroy or occupy a target building/fort/base/crystal deep in the opponent's region.

In one embodiment, each team includes one or more virtual objects, such as 1, 2, 3, or 5. According to a quantity of virtual objects in each team participating in the game battle, the battle arena may be divided into 1V1 competition, 2V2 competition, 3V3 competition, 5V5 competition, and the like. 1V1 means “1 vs. 1”, and details are not described herein.

In one embodiment, the MOBA game takes place in rounds (or turns), and the same scene map or different scene maps may be selected in each round. The duration of each round of the MOBA game is from a moment at which the game starts to a moment at which the victory condition is satisfied by any team or camp.

In a MOBA game, a user can select different main controlled virtual objects in different games. A main controlled virtual object selected in each game cannot be changed in this game, but a different main controlled virtual object can be selected in another game. After selecting a main controlled virtual object, a user can control the main controlled virtual object to cast virtual skills in the virtual scene, thereby achieving the effect of interacting with other virtual objects in the opponent's camp.

The following introduces two typical MOBA games separately.

First typical MOBA game:

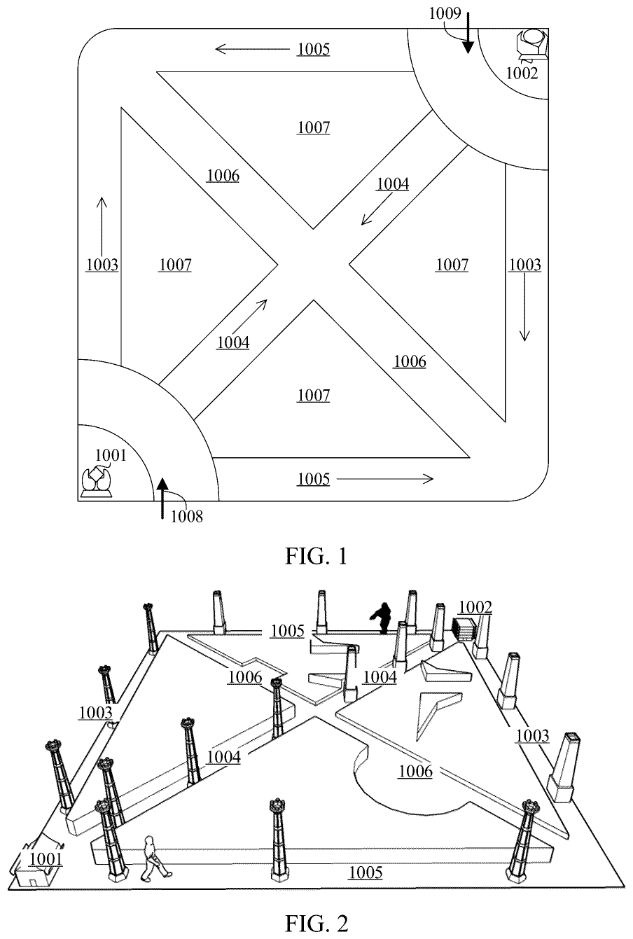

FIG. 1 is a two-dimensional map of a virtual world of a typical MOBA game.

In this typical MOBA game, virtual characters are divided into two camps, a red camp and a blue camp. Each camp has five virtual characters, and a total of ten virtual characters perform a MOBA game battle together.

As shown in FIG. 1, the map of the virtual world is square and is divided into the following parts: bases (crystals) of the two camps at both ends of a diagonal of the square, namely a blue base 1001 and a red base 1002; three attack lanes connecting the blue base 1001 and the red base 1002, namely a top lane 1003, a middle lane 1004, and a bottom lane 1005; and public areas, namely a river 1006 and a jungle 1007.

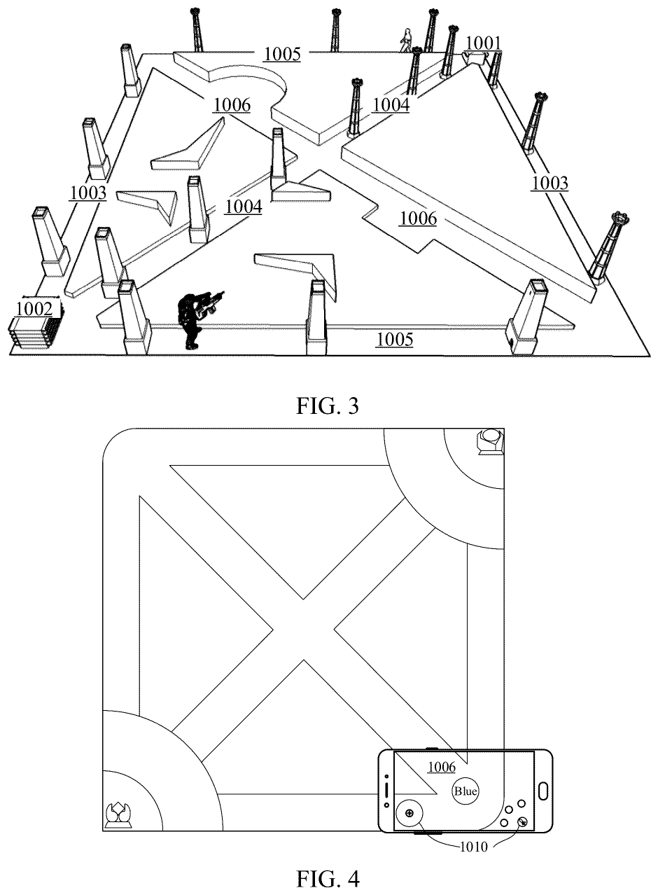

The virtual characters of the two camps are born at their respective base positions, and the five virtual characters of the same camp attack the opponent along three attack directions separately. The game can be won by destroying the base of the opposing camp. The blue camp is born in the blue base 1001, the red camp is born in the red base 1002, and the virtual characters of the two camps observe the virtual world from perspectives of respective bases located in lower left corners of observation perspectives. That is to say, a virtual character of the blue party observes the virtual world from a first perspective 1008, a virtual character of the red party observes the virtual world from a second perspective 1009, and for their respective perspectives, the three attack directions are the top lane, the middle lane, and the bottom lane from left to right. For example, FIG. 2 shows the virtual world observed from the first perspective 1008 of the virtual character of the blue party, where the blue base 1001 is located in the lower left corner of the virtual world screen; FIG. 3 shows the virtual world observed from the second perspective 1009 of the virtual character of the red party, where the red base 1002 is located in the lower left corner of the virtual world screen.

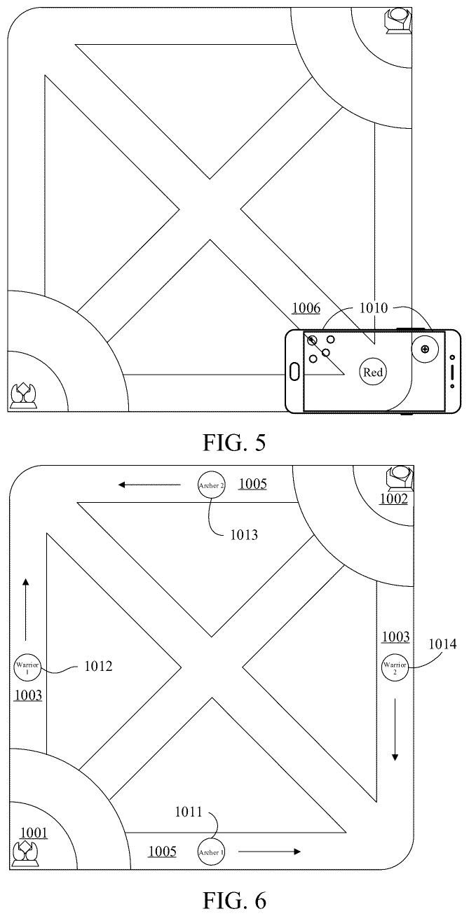

By setting the perspectives of the two camps in this way, no matter whether the virtual character controlled by the user belongs to the red camp or the blue camp, the base of the opposing camp is always in the upper right corner of the virtual world screen, and the attack direction of the virtual character is always in the upper right direction of the virtual world screen, which helps the user to control the virtual character. However, there is also a problem with this setting, that is, the bottom lane of the blue party is the top lane of the red party. When the virtual character of the blue party and the virtual character of the red party are both located at the junction (river) of the bottom lane of the blue party and the top lane of the red party, a UI seen by a user of the blue party on a terminal is shown in FIG. 4. Part of the virtual world screen is blocked by a UI control 1010, but the area of the more dangerous river 1006 (the virtual character of the red party, such as an assassin, may suddenly attack from the river 1006) is not blocked, so the user of the blue party has a wider field of view. A UI that the red party sees on a terminal is shown in FIG. 5. Similarly, part of the virtual world screen is blocked by the UI control 1010, and the area of the more dangerous river 1006 is blocked by the UI control, which affects the field of view of a user of the red party, making it difficult for the user of the red party to observe the area of the river 1006 and making it easy for the user of the red party to be defeated by an assassin of the blue party.

Therefore, the bottom lane 1005 is safer than the top lane 1003.

The five virtual characters in the same camp are usually five different types of virtual characters. For example, the types of the virtual characters may be:

Warrior: It has many health points, high defense power, high attack power, short attack range, and flexible movement, usually has certain displacement skills, and can resist the opponent's damage to a certain extent, or cause damage to the opponent. The displacement skill is a skill that can make the virtual character move faster, or rush a certain distance in a certain direction, or move from one point to another point instantly.

Mage: It has extremely few health points, extremely low defense power, very high attack power as spell damage, long attack range, and inflexible movement, and is easy to be defeated, and therefore usually attacks the opponent under the protection of a warrior or tank/support.

Tank/Support: It has very many health points, very high defense power, extremely low attack power, and short attack range, and is usually suitable for blocking damage for teammates in the front of the team and protecting other teammates.

Archer: It is similar to the mage, but the difference is that the archer has very high physical damage, and is suitable for continuous output and attacking defense towers and bases.

Assassin: It has few health points, low defense power, high attack power, short attack range, and very flexible movement, usually has many displacement skills, is suitable for launching assaults on the opponent's mage or archer, and has the ability to instantly defeat the opponent's mage or archer.

Since different types of virtual characters have their own characteristics, different types of virtual characters usually attack the opponent in fixed directions with reference to the advantages and disadvantages of the upper and bottom lanes in terms of field of view. Usually, the archer (and tank/support) attacks the opponent from the safer bottom lane 1005; the mage attacks the opponent from the middle lane 1004; the warrior with a certain displacement advantage attacks the opponent from the more dangerous top lane 1003; the assassin is mainly active in the jungle 1007, waiting for an opportunity to support teammates in the top lane, the middle lane 1004, or the bottom lane 1005.

This will cause the virtual character to confront an opposing virtual character of a different type from itself, the archer of the blue party confronts the warrior of the red party, and the warrior of the blue party confronts the archer of the red party, affecting the fairness of the game and the user's experience. For example, as shown in FIG. 6, the blue party's first archer 1011 attacks the red party from the blue party's bottom lane 1005, the blue party's first warrior 1012 attacks the red party from the blue party's top lane 1003, the red party's second archer 1013 attacks the blue party from the red party's bottom lane 1005, and the red party's second warrior 1014 attacks the blue party from the red party's top lane 1003. That is to say, the first archer 1011 confronts the second warrior 1014, and the first warrior 1012 confronts the second archer 1013.

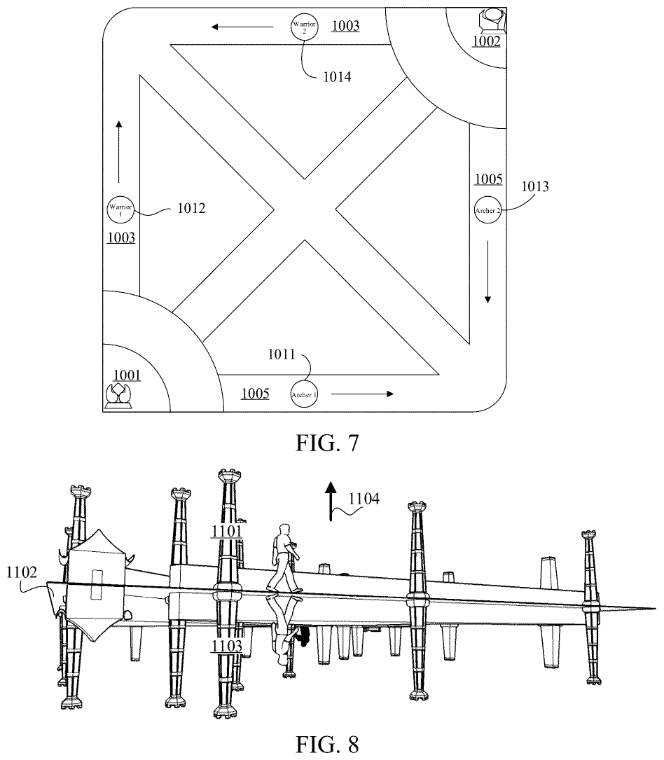

To make the game fairer, a more reasonable confrontation manner is shown in FIG. 7. The blue party's first archer 1011 confronts the red party's second archer 1013, and the blue party's first warrior 1012 confronts the red party's second warrior 1014. To implement such a confrontation manner, it is necessary to solve the problem of how to make the bottom lane of the blue party and the bottom lane of the red party be the same lane, that is, the upper and bottom lanes of one of the blue party or the red party are exchanged, so that the original bottom lane becomes the top lane, and the original top lane becomes the bottom lane. For example, the upper and bottom lanes of the red party are changed into the positions of the top lane 1003 and the bottom lane 1005 shown in FIG. 7. Therefore, the bottom lane 1005 of the blue party is equally the bottom lane 1005 of the red party, and the top lane 1003 of the blue party is equally the top lane 1003 of the red party.

A second typical MOBA game implements this more reasonable confrontation manner.

Second typical MOBA game:

The second typical MOBA game is the same as the first typical MOBA game in terms of gameplay, and also has a square virtual world. The bases of the first camp and the second camp are also located on the diagonal of the square. The five virtual characters in each camp also attack the opponent in three attack directions separately. The difference is that the bottom lane of the first camp is also the bottom lane of the second camp and the top lane of the first camp is also the top lane of the second camp. The second typical MOBA game implements this more reasonable confrontation manner in the following method.

The game battle has a first virtual world and a second virtual world that is a mirror image with respect to the ground plane of the first virtual world. As shown in FIG. 8, the game battle has a first virtual world 1101 and a second virtual world 1103 that is symmetrical to the first virtual world 1101 with respect to a ground plane 1102, that is, the second virtual world is an inverted mirror image of the first virtual world.

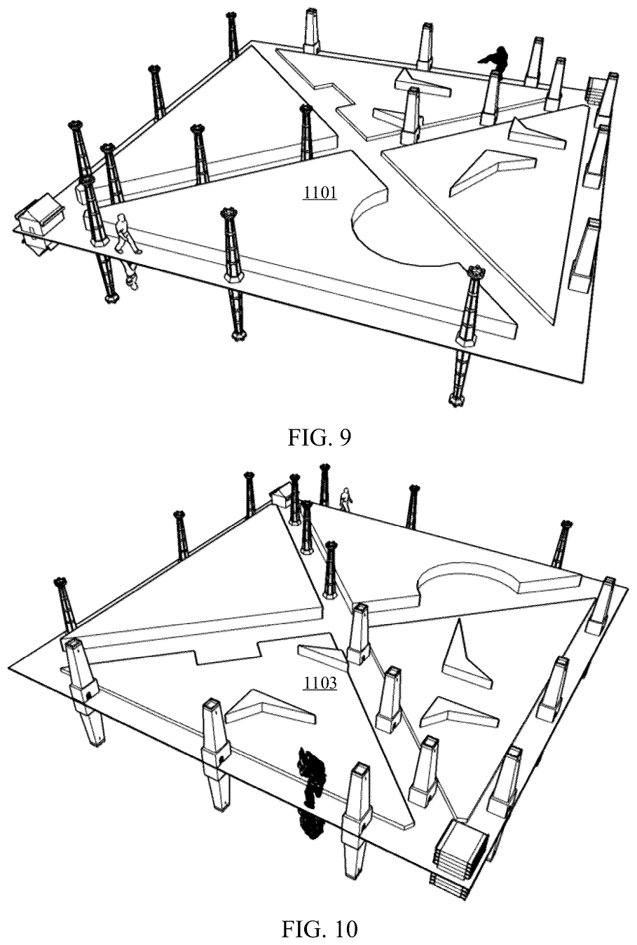

If the direction perpendicular to the ground plane of the first virtual world and pointing to the sky is the positive semi-axis direction 1104 of the y-axis, the virtual world seen by the user controlling the virtual character of the first camp is the first virtual world observed in the space where the perspective is located on the positive semi-axis of the y-axis, as shown in FIG. 9, the first virtual world observed by the user controlling the virtual character of the first camp. The virtual world seen by the user controlling the virtual character of the second camp is the second virtual world observed in the space where the perspective is located on the negative semi-axis of the y-axis, as shown in FIG. 10, the second virtual world observed by the user controlling the virtual character of the second camp. It can be seen that the first virtual world 1101 and the second virtual world 1103 are bilaterally symmetrical worlds. This method can swap the upper and bottom lanes of the second camp. The bottom lane seen by the user controlling the virtual character of the second camp is also the bottom lane seen by the user controlling the virtual character of the first camp.

The second typical MOBA game displays two mutually mirrored virtual worlds to users in two camps respectively, where the user in the first camp observes the first virtual world from the perspective of the positive semi-axis of the y-axis and controls the virtual character to move in the first virtual world; the user in the second camp observes the second virtual world from the perspective of the negative semi-axis of the y-axis and controls the virtual character to move in the second virtual world. Since the first virtual world and the second virtual world are two completely opposite worlds, the server needs to set two sets of operation logic for the first virtual world and the second virtual world respectively. The first operation logic is used to calculate the activity information of the virtual character of the first camp in the first virtual world, such as a movement position and a skill casting direction, and the second operation logic is used to calculate the activity information of the virtual character of the second camp in the second virtual world. After that, the operation result of one virtual world further needs to be displayed in the other virtual world.

The following describes a system architecture related to this disclosure.

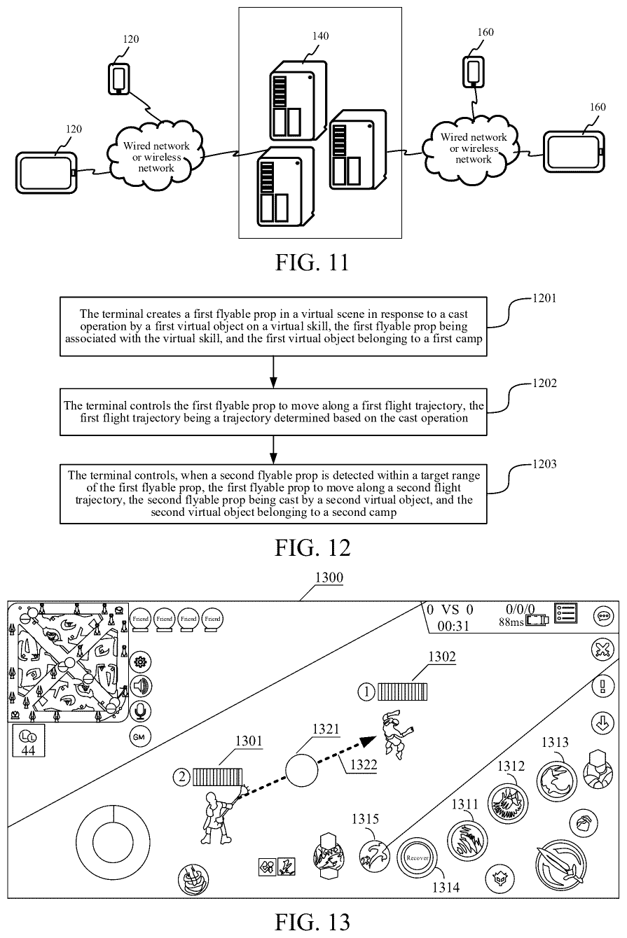

FIG. 11 is a schematic diagram of an implementation environment of an interaction method based on a flyable prop according to an embodiment of this disclosure. Referring to FIG. 11, the implementation environment includes: a first terminal 120, a server 140, and a second terminal 160.

An application program supporting a virtual scene is installed and run on the first terminal 120. The application program may be any one of a MOBA game, a massively multiplayer online role playing game (MMORPG), a first-person shooting (FPS) game, a third-person shooting game, a virtual reality application program, a three-dimensional map program, or a multiplayer weapon survival game. The first terminal 120 may be a terminal used by a first user, and the first user uses the first terminal 120 to operate a first virtual object in the virtual scene to perform a movement. The movement includes, but is not limited to, at least one of body posture adjustment, crawling, walking, running, cycling, jumping, driving, picking-up, shooting, attacking, throwing, and casting of a virtual skill. For example, the first virtual object is a first virtual character such as a simulated character role or a cartoon character role.

The server 140 may include at least one of one server, a plurality of servers, a cloud computing platform, and a virtualization center. The server 140 is configured to provide a backend service for an application program supporting a virtual scene. In one embodiment, the server 140 may be responsible for primary computing work, and the first terminal 120 and the second terminal 160 may be responsible for secondary computing work; or the server 140 is responsible for secondary computing work, and the first terminal 120 and the second terminal 160 are responsible for primary computing work; or the server 140, the first terminal 120 and the second terminal 160 perform collaborative computing by using a distributed computing architecture among each other.

An application program supporting a virtual scene is installed and run on the second terminal 160. The application may be any one of a MOBA game, an MMORPG, an FPS game, a third-person shooting game, a virtual reality application program, a three-dimensional map program, or a multiplayer weapon survival game. The second terminal 160 may be a terminal used by a second user, and the second user uses the second terminal 160 to operate a second virtual object in the virtual scene to perform a movement. The movement includes, but is not limited to, at least one of body posture adjustment, crawling, walking, running, cycling, jumping, driving, picking-up, shooting, attacking, throwing, and casting of a virtual skill. For example, the second virtual object is a second virtual character, such as a simulated person role or a cartoon character role.

The first terminal 120 and the second terminal 160 may be directly or indirectly connected to the server 140 in a wired or wireless communication manner. The connection manner is not limited in the embodiments of this disclosure.

In some embodiments, the first virtual object controlled by the first terminal 120 and the second virtual object controlled by the second terminal 160 are located in the same virtual scene, and in this case, the first virtual object may interact with the second virtual object in the virtual scene.

In some embodiments, the first virtual object and the second virtual object may be in an adversarial relationship, for example, the first virtual object and the second virtual object may belong to different teams and camps. The virtual objects in the opposing relationship may battle against each other by casting virtual skills, for example, the first virtual object casts an attack skill to the second virtual object. In the subsequent embodiments, the adversarial relationship between the first virtual object and the second virtual object is taken as an example for explanation.

In some other embodiments, the first virtual object and the second virtual object may be teammates, for example, the first virtual object and the second virtual object may belong to the same team or the same organization, and have a friend relationship with each other or have a temporary communication permission. In this case, the first virtual object may cast an auxiliary skill to the second virtual object.

The server 140 may be an independent physical server, or may be a server cluster or a distributed system formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an Artificial Intelligence (AI) platform.

The first terminal 120 or the second terminal 160 may be a smartphone, a smart handheld game console, a portable game device, a tablet computer, a notebook computer, a desktop computer, a smart speaker, a smartwatch, a Moving Picture Experts Group Audio Layer III (MP3) player, a Moving Picture Experts Group Audio Layer IV (MP4) player, an e-book reader, or the like, but is not limited thereto.

The application programs installed on the first terminal 120 and the second terminal 160 may be the same, or the application programs installed on the two terminals are the same type of application programs on different operating system platforms. The first terminal 120 may be generally one of a plurality of terminals, and the second terminal 160 may be generally one of a plurality of terminals. In this embodiment, only the first terminal 120 and the second terminal 160 are used for description. The device types of the first terminal 120 and the second terminal 160 may be the same or different.

A person skilled in the art may recognize that there may be more or fewer terminals. For example, there may be only one terminal, or there may be dozens of or hundreds of terminals or more. The quantity and the device type of the terminals are not limited in this embodiment of this disclosure.

FIG. 12 is a flowchart of an interaction method based on a flyable prop according to an embodiment of this disclosure. Referring to FIG. 12, the embodiment is performed by an electronic device. Descriptions are made by using an example in which the electronic device is a terminal. This embodiment includes the following operations.

1201: The terminal creates a first flyable prop in a virtual scene in response to a cast operation by a first virtual object on a virtual skill, the first flyable prop being associated with the virtual skill, and the first virtual object belonging to a first camp.

The first virtual object involved in this embodiment of this disclosure refers to a virtual object mainly controlled by a user using the terminal. A camp to which the first virtual object belongs is referred to as the first camp. For example, two camps, namely the first camp to which the first virtual object belongs and a second camp to which a second virtual object belongs are involved in a MOBA game. The first camp and the second camp are different camps. For example, the first camp and the second camp are in an adversarial relationship with each other.

The virtual skill involved in this embodiment of this disclosure refers to any virtual skill that can be cast by the first virtual object and that can summon a flyable prop. That is, the virtual skill may be a virtual skill bound or dedicated to the first virtual object, or may be a virtual skill universal to all virtual objects. The virtual skill is not specifically limited herein.

The flyable prop involved in the embodiments of this disclosure refers to a virtual prop that is generated, summoned, cast, or created after the first virtual object casts the virtual skill and that can fly in the virtual scene. For example, the flyable prop is a launched object, a thrown object, a summoned object, a flying pet, a flying vehicle, or the like of the virtual skill. The first flyable prop is associated with the virtual skill, which may be understood as that the virtual skill is configured to generate, summon, cast, or create the first flyable prop.

In some embodiments, the user starts a game application on the terminal, performs a battle start operation in the game application, to start a game battle. Next, the terminal loads and displays a virtual scene of the game battle in the game application, and displays, in the virtual scene, a first virtual object mainly controlled by the terminal. In one embodiment, before battle start, the user may select, in a battle start interface, a first virtual object that needs to emerge in this game battle from a plurality of selectable virtual objects. For example, the user selects a main controlled hero that is consistent with the current lane division positioning from a pool of heroes owned by the user as the first virtual object. Alternatively, if the user does not make a selection, the system may allocate the first virtual object of this game battle to the user. The allocation method may be random allocation. A hero with the highest emerging frequency in an account bound to the user may be preferentially selected, or a hero with a highest operation score in an account bound to the user is selected, which is not specifically limited in the embodiments of this disclosure.

In some embodiments, after the selection or allocation of the first virtual object is completed, a dedicated virtual skill of the first virtual object is automatically carried or equipped in the game battle. In addition, in a battle start interface, the user may further select a specified quantity of universal virtual skills, to carry the universal virtual skills into the game battle too, so that the first virtual object can cast both the dedicated virtual skill and the universal virtual skills. The specified quantity is determined by service logic of the game application, and is not limited herein.

In some embodiments, after loading the virtual scene, the user can control the first virtual object to interact in the virtual scene. In one embodiment, when the first virtual object has a virtual skill that can generate, summon, cast, or create a flyable prop, if detecting a cast operation by the user on the virtual skill, the terminal creates a first flyable prop bound to the virtual skill in the virtual scene, where the first flyable prop refers to a flyable prop created by the first virtual object through the virtual skill.

In some embodiments, the foregoing cast operation on the virtual skill includes, but is not limited to: a tap operation, a touch operation, a press operation, a drag operation, a slide operation, and the like on a skill control of the virtual skill. The user can further control a cast direction of the virtual skill through a joystick control. Implementation of the cast operation is not specifically limited in this embodiment of this disclosure.

In some embodiments, after detecting a cast operation on the virtual skill, the terminal determines whether the virtual skill can summon a flyable prop. If the virtual skill can summon a flyable prop, a query is made in a buffer by using a skill identifier (ID) of the virtual skill as an index to obtain a prop resource stored in association with the skill ID. The prop resource is configured to display the first flyable prop. Then, the terminal renders the prop resource by using a rendering engine to display the first flyable prop in the virtual scene. In one embodiment, the terminal has skill configuration information buffeted therein. The skill configuration information includes an association relationship between a skill ID and a prop resource ID. The association relationship between the skill ID and the prop resource ID indicates that a virtual skill indicated by the skill ID is associated with a virtual prop indicated by the prop resource ID. Therefore, the terminal may determine, according to the skill configuration information, a prop resource of the first flyable prop associated with the virtual skill, and then render the prop resource to obtain the first flyable prop.

1202: The terminal controls the first flyable prop to move along a first flight trajectory, the first flight trajectory being a trajectory determined based on the cast operation.

In some embodiments, the terminal may determine a cast direction of the virtual skill based on the cast operation performed by the user on the virtual skill in operation 1201, and then generate a first flight trajectory according to the cast direction of the virtual skill.

In one embodiment, the cast direction of the virtual skill may be specified by the user through the joystick control. For example, after the user presses and holds the joystick control with a finger to select the cast direction, the cast operation on the virtual skill is performed. In this way, the cast direction determined based on the joystick control may be directly obtained. The cast direction may be a direction indicated by a center point of the joystick control in a screen of the terminal pointing toward a touch point of the user's finger. In this way, the user can press the skill control with one hand to trigger the cast operation, and control the joystick control with the other hand to fine-adjust the cast direction, which has a high operation freedom.

In one embodiment, the cast direction of the virtual skill may be specified by the user through the skill control. For example, after pressing and holding the skill control of the virtual skill with a finger, the user may perform a slide operation in the cast direction, and trigger and cast the virtual skill after the user loosens the hand (that is, after the slide operation ends). The cast direction may be a slide direction of the slide operation. In this way, the user can directly operate the skill control with a single hand, and at the same time select a cast direction and trigger a cast operation, which can simplify a human-computer interaction process of the user.

In one embodiment, the cast direction of the virtual skill may be a cast direction automatically determined by the terminal after the user selects a cast target. For example, after the user locks an interaction focus to a cast target, the virtual skill triggered by the user is automatically locked to the cast target. The cast target may be a virtual object of an opponent camp or some non-player controlled virtual objects such as a wild monster, a soldier, or a base. For example, the terminal automatically uses a direction from the first virtual object to the cast target in the current frame as the cast direction of the virtual skill.

In some embodiments, when the virtual skill casts only a single first flyable prop, the first flight trajectory may be a ray trajectory that uses the current position of the first virtual object as a starting point and points toward a cast direction of the virtual skill, so that the terminal may control the first flyable prop to move along the ray trajectory.

FIG. 13 is a schematic diagram of a ray trajectory of a single first flyable prop according to an embodiment of this disclosure. A first virtual object 1301 and a second virtual object 1302 are displayed in a virtual scene 1300. The first virtual object 1301 belongs to a first camp, and the second virtual object 1302 belongs to a second camp. The first camp and the second camp are in an adversarial relationship with each other. In an example, the first virtual object 1301 is equipped with dedicated virtual skills 1311 to 1313 and universal virtual skills 1314 to 1315. In one embodiment, when a user controls the first virtual object 1301 to cast the virtual skill 1311, a first flyable prop 1321 summoned by the virtual skill 1311 is created in the virtual scene 1300, and the first flyable prop 1321 moves along a ray trajectory 1322. The ray trajectory 1322 is a ray that points from the first virtual object 1301 toward the second virtual object 1302. The ray trajectory 1322 is an example illustration of a first flight trajectory.

In some other embodiments, when a virtual skill can cast a plurality of first flyable props, first flight trajectories may be a plurality of ray trajectories starting from the current position of the first virtual object and pointing toward a cast direction of the virtual skill, and angular differences between the plurality of ray trajectories may be the same or different. For example, a ray trajectory of a first flyable prop located in the center in the plurality of first flyable props is set to overlap with the cast direction, and a constant angular difference is maintained between ray trajectories of each of the remaining first flyable props and an adjacent first flyable prop. In this way, an effect similar to scattering of the plurality of first flyable props can be created.

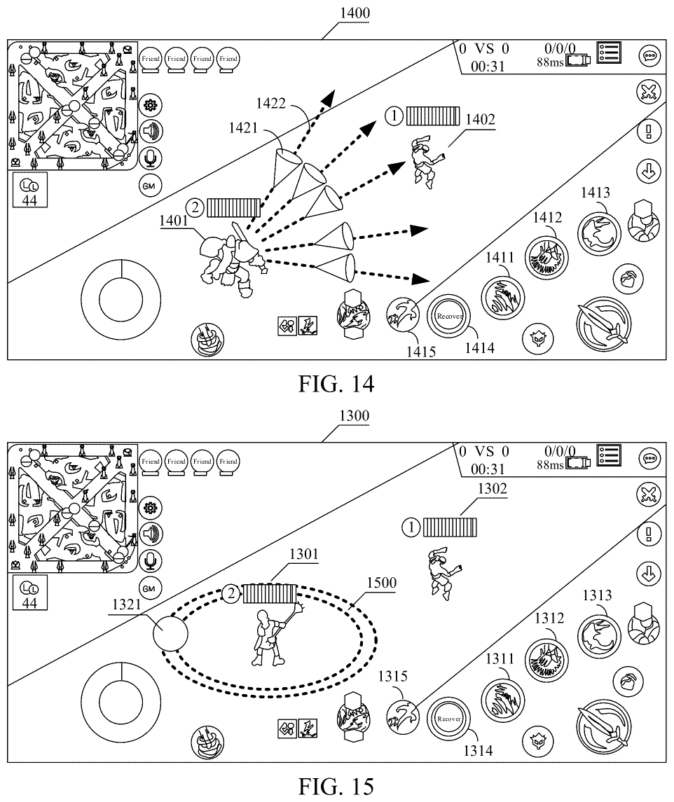

FIG. 14 is a schematic diagram of ray trajectories of a plurality of first flyable props according to an embodiment of this disclosure. A first virtual object 1401 and a second virtual object 1402 are displayed in a virtual scene 1400. The first virtual object 1401 belongs to a first camp, and the second virtual object 1402 belongs to a second camp. The first camp and the second camp are in an adversarial relationship with each other. In an example, the first virtual object 1401 is equipped with dedicated virtual skills 1411 to 1413 and universal virtual skills 1414 to 1415. In one embodiment, when the user controls the first virtual object 1401 to cast the virtual skill 1411, a plurality of first flyable props 1421 summoned by the virtual skill 1411 are created in the virtual scene 1400. Herein, five first flyable props 1421 are summoned as an example for description. Each first flyable prop 1421 moves along a ray trajectory 1422. The ray trajectory 1422 is also an example description of a first flight trajectory.

1203: The terminal controls, when a second flyable prop is detected within a target range of the first flyable prop, the first flyable prop to move along a second flight trajectory, the second flyable prop being cast by a second virtual object, and the second virtual object belonging to a second camp.

In some embodiments, during movement of the first flyable prop along the first flight trajectory, the terminal may perform collision detection on the first flyable prop, that is, detect whether a second flyable prop exists within the target range of the first flyable prop, where the second flyable prop is a flyable prop cast by the second virtual object of the second camp. In this way, if the second flyable prop is detected within the target range of the first flyable prop, the first flyable prop is controlled to change the flight trajectory. For example, a new second flight trajectory is generated for the first flyable prop, and the first flyable prop is controlled to move along the second flight trajectory. The second flight trajectory is different from the first flight trajectory. If flyable props cast by other virtual objects of the first camp is detected within the target range of the first flyable prop, since the flyable props all belong to the first camp, no change of the flight trajectory is triggered.

In some embodiments, the target range of the first flyable prop refers to a range in the three-dimensional virtual scene in which a distance to the first flyable prop is not greater than a preset distance. For example, the target range is a spherical region with the first flyable prop as the circle center and the preset distance as the radius. That is, when the distance between the second flyable prop and the first flyable prop is not greater than the preset distance, it is considered that the second flyable prop is detected within the target range of the first flyable prop. In some other embodiments, the target range is a range in which the second flyable prop is located at the same horizontal plane as the first flyable prop and the distance to the first flyable prop is not greater than the preset distance. For example, the target range is a circular region with the first flyable prop as the circle center and the preset distance as the radius in the horizontal plane in which the first flyable prop is located. That is, when the second flyable prop and the first flyable prop are located at the same horizontal plane, and the distance between the second flyable prop and the first flyable prop is not greater than the preset distance, it is considered that the second flyable prop is detected within the target range of the first flyable prop. Alternatively, the target range of the first flyable prop refers to the position occupied by the first flyable prop. In other words, when there is an overlap between the position occupied by the second flyable prop and the position occupied by the first flyable prop, it is considered that the second flyable prop is detected within the target range of the first flyable prop.

In some embodiments, when the virtual skill casts only a single first flyable prop, the second flight trajectory may be an annular trajectory that encloses the first virtual object. For example, the second flight trajectory is an annular trajectory with the first virtual object as the circle center. In this way, after detecting that there is the second flyable prop within the target range of the first flyable prop, the terminal controls the first flyable prop to move along the second flight trajectory. That is, after the first flyable prop collides with the second flyable prop, originally moving, by the first flyable prop, along the ray trajectory is switched to moving, by the first flyable prop, around the first virtual object along the annular trajectory.

FIG. 15 is a schematic diagram of an annular trajectory of a single first flyable prop according to an embodiment of this disclosure. On the basis shown in FIG. 13 that the user controls the first virtual object 1301 to cast the virtual skill 1311, to summon the first flyable prop 1321 in the virtual scene 1300, if a second flyable prop (not shown in FIG. 15) cast by the second virtual object 1302 is detected within the target range of the first flyable prop 1321 during flying of the first flyable prop 1321 along the first flight trajectory, it is considered that the first flyable prop 1321 collides with the second flyable prop. In this case, a new annular trajectory 1500 is generated for the first flyable prop 1321. The annular trajectory 1500 may be a circular ring or an elliptical ring that encloses the first virtual object 1301. The first virtual object 1301 may be in the center or at any position in the interior of the annular trajectory 1500. The annular trajectory 1500 is an example description of a second flight trajectory.

By comparing FIG. 13 with FIG. 15, it can be seen that originally the first flyable prop moves according to the preset first flight trajectory, and disappears after reaching effective duration, reaching a flight range, or colliding with another virtual object (and causing a specific action effect, which may be a buffing effect or a debuffing effect). However, in the technical solution provided in this embodiment of this disclosure, a novel interaction manner of changing a flight trajectory can be provided after the first flyable prop collides with the second flyable prop. The first flyable prop is switched from the original ray trajectory to the annular trajectory. This greatly improves the prop resource utilization of the first flyable prop, and the flying manners also become richer, thereby improving the human-computer interaction efficiency.

In some other embodiments, when the virtual skill can cast a plurality of first flyable props, second flight trajectories may be a plurality of annular trajectories that enclose the first virtual object. The plurality of annular trajectories may be in a layout manner of concentric circles with the first virtual object as a circle center. Alternatively, the plurality of annular trajectories may be in an interlaced series of non-concentric circles. This is not specifically limited in the embodiments of this disclosure. In this way, after detecting that there is a second flyable prop within the target range of any first flyable prop, the terminal controls all the first flyable props cast by the virtual skill to move along respective second flight trajectories. That is, after the any first flyable prop collides with the second flyable prop, originally moving, by all the first flyable props, along the respective ray trajectories is switched to moving, by all the first flyable props, around the first virtual object along the respective annular trajectories.

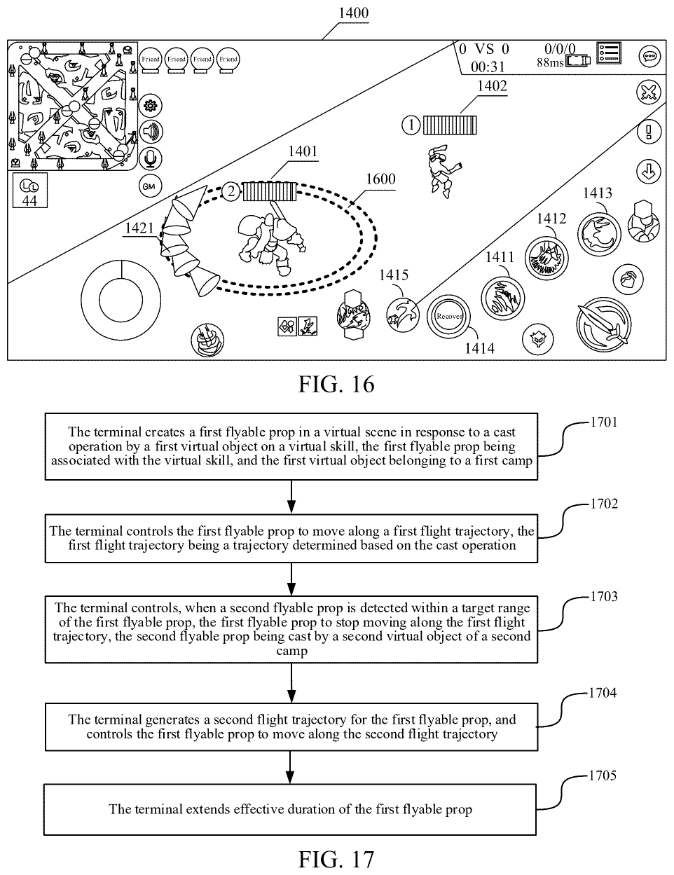

FIG. 16 is a schematic diagram of annular trajectories of a plurality of first flyable props according to an embodiment of this disclosure. On the basis shown in FIG. 14 that the user controls the first virtual object 1401 to cast the virtual skill 1411, to summon the plurality of first flyable props 1421 in the virtual scene 1400, if a second flyable prop (not shown in FIG. 16) cast by the second virtual object 1402 is detected within a target range of any first flyable prop 1421 during flying of the any first flyable prop 1421 along the first flight trajectory, it is considered that the first flyable prop 1421 collides with the second flyable prop. In this case, a new annular trajectory 1600 is generated for each first flyable prop 1421. The annular trajectory 1600 may be a circular ring or an elliptical ring that encloses the first virtual object 1401. Different annular trajectories 1600 may form concentric circular rings or non-concentric circular rings. The first virtual object 1401 may be in the center or at any position in the interior of the annular trajectories 1600. The annular trajectory 1600 is an example description of a second flight trajectory.

By comparing FIG. 14 with FIG. 16, it can be seen that originally the plurality of first flyable props move according to the respective preset first flight trajectories, and disappear after reaching effective duration, reaching a flight range, or colliding with another virtual object (and causing a specific action effect, which may be a buffing effect or a debuffing effect). However, in the technical solution provided in this embodiment of this disclosure, a novel interaction manner of changing a flight trajectory can be provided after any first flyable prop collides with the second flyable prop. Each first flyable prop is switched from the original ray trajectory to the annular trajectory. This greatly improves the prop resource utilization of the first flyable prop, and the flying manners also become richer, thereby improving the human-computer interaction efficiency.

In the foregoing process, since originally in the MOBA game, each type of flyable prop is usually dedicated to a specified virtual skill of a specified virtual object, and the flyable prop has limited effective duration and a fixed flying manner (movement along the first flight trajectory), this makes the prop resource utilization of flyable props designed by a large number of technicians low. However, in the technical solution provided in this embodiment of this disclosure, because a set of innovative interaction manners based on a flyable prop are designed, when flyable props of different camps collide, a flight trajectory of a flyable prop of one party is changed, so that the flight trajectory of the flyable prop is rich in changes and is not limited to a preset flight trajectory. The game performance is enriched, the prop resource utilization is improved, and the human-computer interaction efficiency is improved.

In addition, since the flyable prop changes the flight trajectory after colliding with a flyable prop of another camp while moving along the fixed flight trajectory, during a battle of virtual objects of different camps, if a virtual object of the first camp casts a virtual skill to summon the first flyable prop to attack a virtual object of the second camp along the first flight trajectory, the virtual object of the second camp may cast a virtual skill to summon the second flyable prop to collide with the first flyable prop, so that the first flyable prop changes the flight trajectory and consequently cannot attack the virtual object of the second camp. It is equivalent to that the flyable prop may be intercepted by colliding with the flyable prop, so that the flyable prop cannot function. In this way, the flexibility of the flyable prop is improved, and the function of the flyable prop is also expanded. The player is prompted to actively develop a battle strategy around the flyable prop and flexibly adjust the battle strategy using the flyable prop. The gameplay is enriched, the enthusiasm of the player to participate in the battle is motivated, the human-computer interaction efficiency is improved, and the battle experience of the player is improved.

Any combination of all the foregoing technical solutions can be used to form embodiments of the present disclosure. Details are not described herein again.

In the technical solution provided in this embodiment of this disclosure, when the second flyable prop is detected within the target range of the first flyable prop, since camps of the first flyable prop and the second flyable prop are different, the first flyable prop is controlled to switch from the first flight trajectory to the second flight trajectory. This makes the flight trajectory of the first flyable prop rich in changes as a game battle progresses, improves prop resource utilization of the first flyable prop, enriches interaction manners based on a flyable prop, and improves human-computer interaction efficiency.

In the previous embodiment, an interaction process based on a flyable prop is briefly described. In this embodiment of this disclosure, detailed implementations of the operations will be described in detail. FIG. 17 is a flowchart of an interaction method based on a flyable prop according to an embodiment of this disclosure. Referring to FIG. 17, the embodiment is performed by an electronic device. Descriptions are made by using an example in which the electronic device is a terminal. This embodiment includes the following operations.

1701: The terminal creates a first flyable prop in a virtual scene in response to a cast operation by a first virtual object on a virtual skill, the first flyable prop being associated with the virtual skill, and the first virtual object belonging to a first camp.

Operation 1701 is the same as operation 1201 in the previous embodiment. Details are not described herein again.

In some embodiments, the terminal may create and manage the first flyable prop through a configuration file. The configuration file involves a plurality of tracks, and each track is configured to manage one type of service logic of the first flyable prop. For example, there may be five tracks involved in the configuration file of the first flyable prop. The five tracks include in sequence from top to bottom:
1| SpawnObjectDuration0//Generate an entity
2| SetCollisionTick0//Add a collision detection box to the entity
3| TriggerParticle3//Add a special effect to the entity
4| MoveBulletDuration4//Move the entity
5| HitTriggerDuration0//Add collision detection logic to the entity

The foregoing entity refers to a first entity of the first flyable prop created in the virtual scene, that is, an initial entity of the first flyable prop, and the foregoing special effect refers to a first special effect carried by the first entity of the first flyable prop created in the virtual scene, that is, an initial special effect of the first flyable prop.

During running of a game application, the terminal may find the configuration file of the first flyable prop in a buffer, and run the configuration file to sequentially execute the service logic of each track in a top-to-bottom order, so that an entity carrying the special effect is created in the virtual scene as the first flyable prop, and the first flyable prop moves according to a cast direction specified by a cast operation. That is, the first flyable prop moves according to the first flight trajectory, and generates a specific action effect on a virtual object of an opponent that is collided with along the way. The foregoing configuration file is a possible implementation of a prop resource of the first flyable prop.

In an example scene, an example is used in which the first flyable prop is a launched object of the virtual skill. When detecting that the user controls the first virtual object to cast the virtual skill, the terminal invokes a function node “1| SpawnBulletTickO” of the game application to generate a bullet object, where the bullet object is an actor object in the game application; then queries a buffer to find a configuration file of the first flyable prop by using a skill ID of the virtual skill as an index; and implements initialized configuration on the bullet object according to service logic provided by each track in the configuration file, so that the first flyable prop can be displayed in the virtual scene and the first flyable prop can be controlled to move along the first flight trajectory.

1702: The terminal controls the first flyable prop to move along a first flight trajectory, the first flight trajectory being a trajectory determined based on the cast operation.

Operation 1702 is the same as operation 1202 in the previous embodiment. Details are not described herein again.

For example, the terminal may define the first flight trajectory through a track “4| MoveBulletDuration4” in the configuration file of the first flyable prop. For example, the first flight trajectory is defined as a ray trajectory that uses the first virtual object as a starting point and points toward a cast direction of the virtual skill, or the first flight trajectory is defined as a straight trajectory pointing toward a cast direction of the virtual skill, or the first flight trajectory may be defined as an arc trajectory, a curved trajectory, a parabolic trajectory, or the like according to a set trajectory function. A specific type of the first flight trajectory is not limited herein.

The first flight trajectory refers to a fixed trajectory preset for the first flyable prop in the configuration file, and is not changed by the progress of the game battle. In other words, regardless of a moment in the game battle at which the user controls the first virtual object to cast the virtual skill, the created first flyable prop first moves according to the first flight trajectory.

1703: The terminal controls, when a second flyable prop is detected within a target range of the first flyable prop, the first flyable prop to stop moving along the first flight trajectory, the second flyable prop being cast by a second virtual object of a second camp.

In some embodiments, the terminal may add a collision detection box to the first flyable prop. The collision detection box may be a collision detection box (which may also be referred to as a collision detection range) mounted on a prop model of the first flyable prop, so that the collision detection box can move with the movement of the first flyable prop, thereby ensuring that the first flyable prop can perform collision detection in real time during movement. In one embodiment, the range delineated by the collision detection box is the target range. A technician may define a size of the target range in the configuration file by using the track “2| SetCollisionTick0”. The size of the target range is not specifically limited herein. If the virtual skill casts a plurality of first flyable props, a collision detection box may be mounted to each first flyable prop. Alternatively, if the first flight trajectories of the plurality of first flyable props are compact, for convenience, all the first flyable props may be mounted with a collision detection box with a large range. This is not specifically limited herein.

In some embodiments, after the terminal mounts the collision detection frame for the first flyable prop cast by the first virtual object, a collision detection frame is also similarly mounted for the second flyable prop cast by the second virtual object. In this way, the terminal may determine, by determining whether there is an intersection between the collision detection box of the first flyable prop and the collision detection box of the second flyable prop, whether the second flyable prop is included in the target range of the first flyable prop. When there is an intersection between the collision detection box of the first flyable prop and the collision detection box of the second flyable prop, it is determined that the second flyable prop is included in the target range of the first flyable prop. When there is no intersection between the collision detection box of the first flyable prop and the collision detection box of the second flyable prop, it is determined that the second flyable prop is not included in the target range of the first flyable prop.

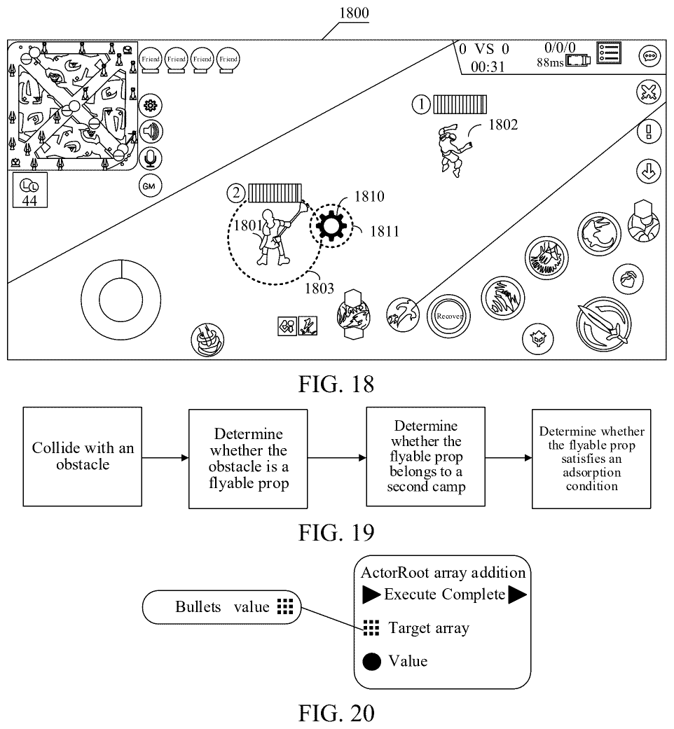

FIG. 18 is a diagram of a principle of a collision detection manner according to an embodiment of this disclosure. In a virtual scene 1800, it is assumed that after a second virtual object 1802 casts a virtual skill, a second flyable prop 1810 is summoned. In this case, a spherical collision detection box 1811 is mounted on a prop model of the second flyable prop 1810. It can be seen that there is an intersection between the collision detection box 1811 of the second flyable prop 1810 and a collision detection box 1803 mounted on a character model of a first virtual object 1801, indicating that the second flyable prop 1810 hits the first virtual object 1801. Therefore, the second flyable prop 1810 generates a corresponding action effect on the first virtual object 1801. For example, a specific virtual health value is deducted for the first virtual object 1801, or a specific virtual defense value is deducted for the first virtual object 1801, or an attack power coefficient is reduced for the first virtual object 1801 within set duration. The action effect of the flyable prop is not specifically limited herein.

In addition to the second flyable prop in the virtual scene, a flyable prop cast by a friendly virtual object, the virtual object itself, a neutral virtual object such as a wild monster, or even some virtual objects may also be mounted with a collision detection box. Therefore, when it is detected that there is an intersection between the collision detection box of the first flyable prop and any collision detection box, the terminal considers that an obstacle is detected within the target range of the first flyable prop, but needs to determine whether the obstacle is the second flyable prop to make a decision about whether to change the flight trajectory of the first flyable prop.

In some embodiments, the manner of detecting whether the obstacle in the target range is the second flyable prop includes the following operations 1713 to 1733:

1713: Obtain, when a virtual object is detected within the target range of the first flyable prop, an object type of the virtual object.

In some embodiments, when it is detected that there is an intersection between the collision detection box of the first flyable prop and any collision detection box, the terminal considers that an obstacle is detected within the target range of the first flyable prop, and then queries for a type of the obstacle; and if the type of the obstacle is a flyable prop, performs operation 1723, and if the type of the obstacle is a virtual object, controls, according to the skill setting of the virtual skill, the first flyable prop to generate an action effect on the virtual object, such as reducing a movement speed of the virtual object, lengthening a skill CD of the virtual object, and reducing virtual health points or a virtual defense power of the virtual object.

1723: Obtain, when the type is a flyable prop, a camp to which the flyable prop belongs.

In some embodiments, when the object type of the obstacle is a flyable prop, a camp to which the flyable prop belongs may be further determined. If the flyable prop belongs to the second camp, operation 1733 is performed. If the flyable prop belongs to the first camp, no processing may be performed, and movement along the first flight trajectory continues.

1733: Determine, when the camp is the second camp and the flyable prop satisfies an adsorption condition, the obstacle as the second flyable prop, the adsorption condition indicating that the flyable prop is able to change a flight trajectory of another flyable prop.

In some embodiments, when the flyable prop belongs to the second camp, it may be further determined whether the flyable prop satisfies the adsorption condition. For example, a prop ID list that satisfies the adsorption condition is stored on the terminal, and then the prop ID list is queried for whether the prop ID of the flyable prop of the second camp detected within the target range is included. If the prop ID of the flyable prop is found by querying the prop ID list that satisfies the adsorption condition, it may be determined that the flyable prop satisfies the adsorption condition, and the flyable prop is determined as a second flyable prop. If the prop ID of the flyable prop is not found by querying the prop ID list that satisfies the adsorption condition, it may be determined that the flyable prop does not satisfy the adsorption condition, that is, the flyable prop does not support changing to a flight trajectory of another flyable prop that is collided with, and then other main service logic of the game may be executed to determine whether to perform no processing or to counteract or absorb a flyable prop of one party.

FIG. 19 is a diagram of a principle of screening a second flyable prop according to an embodiment of this disclosure. As shown in FIG. 19, an example in which a first flyable prop is a first launched object and a second flyable prop is a second launched object is used for description. A collision detection box is mounted on a prop model of each of the first launched object and the second launched object. During movement of the first launched object along a first flight trajectory, once there is an intersection between the collision detection box of the first launched object and any collision detection box, it indicates that the first launched object collides with an obstacle. Then, it is determined whether a type of the obstacle is a flyable prop. If yes, it is further determined whether the flyable prop belongs to a second camp. If yes, it is further determined whether the flyable prop satisfies an adsorption condition. If yes, the flyable prop is determined as the second flyable prop. Otherwise, if a determination result of any determination logic is no, the process is exited.

In some embodiments, to facilitate determining whether any flyable prop satisfies the adsorption condition, when a configuration file of each flyable prop is created, the configuration file may be generally further configured for recording attribute information of the flyable prop, and the attribute information may record a prop name of the flyable prop, a prop ID, a skill ID of a virtual skill to which the flyable prop belongs, an object ID of a virtual object to which the flyable prop belongs, and a camp ID to which the flyable prop belongs, and the like. Next, an adsorption attribute field is newly created in the attribute information. When the value of the adsorption attribute field is True, it indicates that the flyable prop satisfies the adsorption condition. When the value of the adsorption attribute field is False, it indicates that the flyable prop does not satisfy the adsorption condition. In addition, a technician may further set that when there is a default adsorption attribute field, the adsorption condition is satisfied by default or the adsorption condition is not satisfied by default. In this way, after colliding with the obstacle within the target range of the first flyable prop, it is only necessary to access the attribute information in the configuration file of the obstacle, to determine whether the obstacle is a flyable prop according to the ID of the obstacle, determine whether the flyable prop belongs to the second camp according to the camp ID, and determine whether the adsorption condition is satisfied according to the adsorption attribute field. When the object type is a flyable prop, belongs to the second camp, and satisfies the adsorption condition, it is determined that the second flyable prop is detected within the target range of the first flyable prop, and operation 1704 is performed.

In an example, the terminal screens the second flyable prop through the following code. The logic of the following code is the logic of determining whether an obstacle collided with within the target range of the first flyable prop is the second flyable prop.

```
bool SpecialBulletDuration::FilterTargetBullet(const PooledHandle<SGCore::ActorRoot>&
hitActor)
{
  const PooledHandle<SGCore::BaseBulletControler>& hitBulletController = hitActor−
>BulletControl;
  if (AGEProp(bOnlyCheckCollison))
  {
  return(Intersects(hitActor, _coordShape, AGEProp(bEdgeCheck))&&
SGCore::BulletHelper::ContainsTag(hitActor, (BulletTag)AGEProp(targetTag)));
  }
  if (hitBulletController
  && hitBulletController−>m_belongedBulletSkill
  && !hitBulletController−>GetAbilityFlag(SGCore::BulletAbility_IgnoreSpecialBullet)
  && ((hitBulletController−>GetAbilityFlag(SGCore::BulletAbility_CanDestroyed)) ||
(AGEProp(bAbsorbBullet) && hitBulletController−
>GetAbilityFlag(SGCore::BulletAbility_ForceDestroyByAbsorbBullet)))
  && ((AGEProp(targetBulletType) == TargetBulletType_SelfBullet
    && (hitBulletController−>m_belongBulletSkill−>skillContext
    && hitBulletController−>m_belongBulletSkill−>skillContext−>Instigator
    && hitBulletController−>m_belongBulletSkill−>skillContext−>Instigator ==
attackerActor))
    || (AGEProp(targetBulletType) == TargetBulletType_EnemyBullet && hitActor−
>IsEnemyActor(attackerActor))
    || (AGEProp(targetBulletType) == TargetBulletType_NotThis && hitActor !=
triggerActor))
  && (AGEProp(bulletTypeId) <= 0 || hitBulletController−>m_belongedBulletSkill−
>bulletParam−>bulletSkillTypeId == AGEProp(bulletTypeId))
  && Intersects(hitActor, _coordShape, AGEProp(bEdgeCheck))
  && !bDestroyedSelf
  && !hitBulletController−>m_belongedBulletSkill−>IsFinish( )
  && (AGEProp(bDestroyedTarget) || collidedBulletList.Find(hitActor−>m_nObjID) ==
INVALID_INDEX))
  {
  if (AGEProp(bAbsorbBullet) && hitBulletController−
>GetAbilityFlag(SGCore::BulletAbility_NotDestroyByAbsorbBullet))
  {
    return false;
    }
    return false;
  }
  return false;
}
```

In the foregoing operations 1713 to 1733, a plurality of sets of determination logic are set to detect whether the obstacle in the target range is the second flyable prop. In one embodiment, according to a game service requirement, the same or different determination logic may be set for different first flyable props cast by different virtual skills. For example, a type of first flyable prop does not determine whether an adsorption condition is satisfied, which can bring a more flexible and variable fight strategy and playing experience, and helps enrich interaction manners based on a flyable prop. In addition, through the plurality of sets of determination logic of operations 1713 to 1733, it can be ensured that the second flyable prop is a flyable prop belonging to the second camp and satisfying the adsorption condition, which can avoid a case that a subsequent game service logic error is caused after the second flyable prop collides with a flyable prop cast by a friendly virtual object and has a flight trajectory changed.

In some embodiments, after it is detected, through the foregoing operations 1713 to 1733, that there is a second flyable prop in the target range of the first flyable prop, that is, there is an intersection between the collision detection box of the first flyable prop and the collision detection box of the second flyable prop, the first flyable prop needs to be controlled to stop moving on the first flight trajectory. In addition, a collision detection function and a prop movement function of the first flyable prop may be immediately disabled, thereby preventing the first flyable prop from further moving on the first flight trajectory and causing damage.

In an example, an example is used in which the first flyable prop is the first launched object. An action that is being performed by the first launched object is obtained through an actor object of the first launched object, then analysis is performed track by track in the configuration file of the first launched object, to detect a track type to which the current action belongs, and then a target track to which the current action belongs is aborted.

For example, if the track to which the current action belongs is a track of the prop movement function, the first launched object may be controlled to stop moving through the following code logic:

```
for (uint32 i = 0; i < bulletTracks.Count( ); i++)
{
  const PooledHandle<AGE::Track>& bulletTrack = bulletTracks[i];
  if (bulletTrack && bulletTrack−>enabled
    &&(bulletTrack−>TrackPrefix GetTrackEventType( ) ==
AGE::EventType_MoveBulletDuration
    || bulletTrack−> TrackPrefix GetTrackEventType( ) ==
AGE::EventType_BulletTriggerDuration
    || bulletTrack−> TrackPrefix GetTrackEventType( ) ==
AGE::EventType_BezierBulletDuration
    || bulletTrack−>TrackPrefix GetTrackEventType( ) ==
AGE::EventType_TrigonometricBulletDuration))
  {
    bulletTrack−>Stop( );
    bulletTrack−>SetEnabled(false);
  }
}
```

1704: The terminal generates a second flight trajectory for the first flyable prop, and controls the first flyable prop to move along the second flight trajectory.

In some embodiments, after the movement of the first flyable prop on the first flight trajectory is stopped, the first flyable prop may be launched again by using a new second flight trajectory, so that the flight trajectory of the first flyable prop can be changed. The second flight trajectory is different from the first flight trajectory.

In some embodiments, the terminal may first stop service logic of the collision detection function and the prop movement function of the first flyable prop on the first flight trajectory, and then re-assign new service logic to the first flyable prop, which can avoid modifying an intrinsic configuration file of the first flyable prop, to avoid destroying intrinsic service logic of the first flyable prop, and avoid uncontrollable performance when a user subsequently casts a virtual skill again to summon the first flyable prop. In view of this, to change the flight trajectory of the first flyable prop, a second entity may be recreated for the first flyable prop, and then the second entity is combined with the first entity of the first flyable prop. The first entity is an initial entity created when the first flyable prop is created, and the second entity is a new entity created after the first flyable prop collides with the second flyable prop.

In some embodiments, the terminal may first create a second entity carrying a second special effect for the first flyable prop, where the second entity inherits a first entity of the first flyable prop, and the second special effect inherits a first special effect carried by the first entity. That is, as described in operation 1701 above, when the first flyable prop is summoned, an entity has been created for the first flyable prop and a special effect is added to the first flyable prop. The first entity is an initial entity created, and the first special effect is an initial special effect added. Therefore, when the second entity is recreated for the first flyable prop and the second special effect is added to the first flyable prop, the two operations of creating the entity and adding the special effect in the configuration file may be skipped, the second entity carrying the second special effect is obtained by inheriting the first entity carrying the first special effect, and then a prop movement function of the first flyable prop on the second flight trajectory is created.

In some embodiments, after creating the second entity, the terminal may create the second flight trajectory of the second entity based on a collision position between the first flyable prop and the second flyable prop. For example, a loop function is used to set that the second flight trajectory is an annular trajectory that encloses the first virtual object. In this way, when the first flyable prop can be controlled to move along the second flight trajectory, a surrounding motion around the first virtual object is actually performed. A circle center, a radius, and the like of the annular trajectory are all defined and adjusted by the loop function.

In an example, a configuration file of the second entity is created for the first flyable prop as follows:
1| Obtain a second flyable prop collided with by a first flyable prop
2| LoopBulletDuration0//Set the second entity to perform a surrounding motion around the first virtual object
3| ExtendBulletDuration0//Extend effective duration of the second entity

In the foregoing process, the second entity is recreated for the first flyable prop, and the second flight trajectory is generated by using the second entity. In this way, the movement of the first flyable prop can be controlled through a completely new configuration file. Because the second entity and the second special effect inherit the first entity and the first special effect, a creation process of the completely new configuration file is simplified, and processing resources of the terminal are saved.

In addition, the last track “3| ExtendBulletDuration0” in the completely new configuration file can control the effective duration of the first flyable prop having the flight trajectory changed, and can flexibly continue the effective duration (which may even be continued indefinitely) according to a service requirement, or the track is destroyed (that is, the first flyable prop is destroyed).

In the foregoing operations 1703 to 1704, a possible implementation of controlling, when the second flyable prop is detected within the target range of the first flyable prop, the first flyable prop to move along the second flight trajectory is provided. By stopping movement of the first flyable prop on the first flight trajectory, creating a second entity carrying a second special effect to inherit the first entity carrying the first special effect, generating a second flight trajectory for the second entity, and controlling the first flyable prop to move on the second flight trajectory through a configuration file of the second entity, the flight trajectory of the first flyable prop can be switched from the first flight trajectory to the second flight trajectory. This is equivalent to launching (or casting) the first flyable prop again on the second flight trajectory. In this way, damage to the intrinsic configuration file of the first flyable prop can be avoided. In addition, the effective duration of the first flyable prop can be flexibly modified through the configuration file of the second entity, which has a high development freedom.

In some embodiments, when a plurality of first flyable props are cast by a virtual skill at a time, the foregoing operations of creating the second entity and generating the second flight trajectory may be performed on each first flyable prop. However, to facilitate uniform management of the plurality of first flyable props cast by the same virtual skill, and ensure that the plurality of first flyable props cast by the same virtual skill change flight trajectories simultaneously, the terminal may further maintain a flyable prop management array. The flyable prop management array is configured for managing flyable props having flight trajectories changed in the virtual scene. For example, the terminal maintains the foregoing flyable prop management array in a blueprint tool of a game engine, or may maintain the flyable prop array by using another development tool.

Based on the foregoing, after creating the second entity, the terminal may notify a trajectory change event of a first flyable prop to the flyable prop management array, and add the first flyable prop to the flyable prop management array. In this way, each time a second flight trajectory of a first flyable prop is generated, a trajectory change event of the first flyable prop is notified to the flyable prop management array, and the first flyable prop is added to the flyable prop management array. In this way, it is convenient to manage a plurality of first flyable props cast at a time by the same virtual skill, to ensure that the first flyable props change flight trajectories, extend effective duration, and are destroyed simultaneously.

In an example, to facilitate management of the flyable prop management array, the configuration file of the second entity may be modified to the following track logic:

1| Obtain a second flyable prop collided with by a first flyable prop
2| Generate a second flight trajectory
3| Generate a second entity (used by a blueprint tool)
4| Notify the blueprint tool that there is one first flyable prop having a flight trajectory switched
5| Launch the first flyable prop along the second flight trajectory again
6| Extend AGE effective duration of the first flyable prop
7| PrintTickO

FIG. 20 is a schematic diagram of a blueprint tool according to an embodiment of this disclosure. In the blueprint tool, through an ActorRoot array adding function, a target array, namely a flyable prop management array is created, and a first flyable prop Bullet having a flight trajectory changed is added to the flyable prop management array.

In the foregoing manner, through the flyable prop management array, a flyable prop that is summoned by each virtual object after casting a virtual skill in a game battle and that has a flight trajectory changed can be conveniently managed. In this way, after flyable props have flight trajectories changed, regardless of whether effective duration of the flyable props is continuously extended or the flyable props are uniformly destroyed, as long as main service logic of the game notifies the flyable prop management array in the blueprint tool through an event, each flyable prop having the flight trajectory changed can be uniformly managed with high flexibility and freedom, and can be flexibly modified according to the service requirements of the game.

In some embodiments, when the second flyable prop is detected within the target range of the first flyable prop, the first flyable prop is controlled to move along the second flight trajectory, and display of the second flyable prop is canceled. That the display of the second flyable prop is canceled indicates that the second flyable prop is counteracted, destroyed, or adsorbed. That is, when two flyable props collide, one flyable prop has a flight trajectory changed, and the other flyable prop is counteracted, destroyed, or adsorbed.

In some other embodiments, after the second flight trajectory is generated for the first flyable prop, since the first flyable prop has the flight trajectory changed only after colliding with the second flyable prop, a party whose flyable prop has the flight trajectory changed may be determined according to the skill setting of the virtual skill or by comparing the skill levels of the first virtual object and the second virtual object. The flyable prop of the remaining party may be counteracted, or destroyed, or adsorbed (or absorbed) by the first flyable prop, or continue to move along an original fixed trajectory, which may be flexibly set by a technician according to a service requirement of the game. In this embodiment of this disclosure, an example in which the first flyable prop has the flight trajectory changed is used for description.

When the first flyable prop has the flight trajectory changed and the second flyable prop is absorbed by the first flyable prop, the terminal may further change or update a displaying form of the first flyable prop based on the second flyable prop, where the form includes at least one of a physical shape or a flying special effect of the first flyable prop. That is, since the second flyable prop is absorbed by the first flyable prop, the form of the first flyable prop may be changed according to the second flyable prop, so that the first flyable prop having the form changed has part of a physical shape or a flying special effect of the second flyable prop, or a combined shape or combined special effect of the two. Then, the terminal controls the first flyable prop having the form changed to move along the second flight trajectory. In this way, the user can be prompted at a glance that two flyable props fuse after a collision, to improve information obtaining efficiency of the user.

In some embodiments, Since the form includes two aspects: a physical shape and a flying special effect, the terminal may change the form of the first flyable prop in any one of the following manners 1714 to 1734:

1714: The terminal retains the physical shape of the first flyable prop, and assigns a flying special effect of the second flyable prop to the first flyable prop.

In some embodiments, after creating the second entity, the terminal instructs the second entity to inherit the physical shape of the first flyable prop and the flying special effect of the second flyable prop. In this way, the second entity can retain the physical shape of the first flyable prop and have the flying special effect of the second flyable prop, achieving a harmonious and natural fusion effect, and it can be visually seen that the second flyable prop is adsorbed by the first flyable prop.

1724: The terminal retains the flying special effect of the first flyable prop, and assigns a physical shape of the second flyable prop to the first flyable prop.

In some embodiments, after creating the second entity, the terminal instructs the second entity to inherit the physical shape of the second flyable prop and the flying special effect of the first flyable prop. In this way, the second entity can retain the physical shape of the second flyable prop and have the flying special effect of the first flyable prop, achieving a more harmonious and natural fusion effect, and visually indicating that the second flyable prop is adsorbed by the first flyable prop.

1734: The terminal determines a target form based on the form of the first flyable prop and a form of the second flyable prop, and assigns the target form to the first flyable prop.

In some embodiments, after creating the second entity, the terminal fuses the physical shape of the first flyable prop and the physical shape of the second flyable prop to obtain the physical shape of the second entity. For example, the physical shape of the first flyable prop and the physical matching color of the second flyable prop are combined to form the physical shape of the second entity. Alternatively, the physical shape of the second flyable prop and the physical matching color of the first flyable prop are combined to form the physical shape of the second entity. Alternatively, the physical shape of the first flyable prop is retained, and then respective texture maps of the first flyable prop and the second flyable prop are fused through a trained image fusion model to obtain a new target texture map. The prop model of the first flyable prop is rendered through the target texture map. The target texture map may fuse texture features, style features, or the like of the texture maps of the two flyable props. The image fusion model is not specifically limited herein.

In some embodiments, after creating the second entity, the terminal fuses the flying special effect of the first flyable prop and the flying special effect of the second flyable prop to obtain the flying special effect of the second entity. For example, the flying special effects of the two flyable props are simply superimposed. Alternatively, if the virtual skill casts a plurality of first flyable props, one part of the first flyable props may retain their own flying special effects, and the other part of the first flyable props may use the flying special effect of the second flyable prop. This is not specifically limited in the embodiments of this disclosure.

In the foregoing manner, the form of the first flyable prop is changed based on the second flyable prop. In this way, at least one of the physical shape or the flying special effect of the first flyable prop can be changed, so that the two flyable props achieve a more harmonious and natural fusion effect, and similarly it can be visually seen that the second flyable prop is adsorbed by the first flyable prop, thereby improving the information obtaining efficiency of the user.

1705: The terminal extends effective duration of the first flyable prop.

In some embodiments, the terminal may extend the effective duration of the first flyable prop through the track “3| ExtendBulletDuration0” in the configuration file of the second entity described in operation 1704 above. The extension of the effective duration may be set by a technician. For example, the effective duration is extended by 5 seconds or another value each time the second flyable prop is collided with, or only when the second flyable prop is collided with for the first time, the effective duration is extended by 10 seconds or another value, or the effective duration of the first flyable prop may be continuously extended and uniformly destroyed through main service logic in the battle to satisfy flexible and variable service requirements.

In the foregoing operation 1705, the effective duration of the first flyable prop is extended when the second flyable prop is detected within the target range of the first flyable prop. In this way, performance duration of the first flyable prop in the MOBA game can be greatly improved, thereby improving the prop resource utilization from the perspective of extending the effective duration.

Any combination of all the foregoing technical solutions can be used to form embodiments of the present disclosure. Details are not described herein again.

In the technical solution provided in this embodiment of this disclosure, when the second flyable prop is detected within the target range of the first flyable prop, since camps of the first flyable prop and the second flyable prop are different, the first flyable prop is controlled to switch from the first flight trajectory to the second flight trajectory. This makes the flight trajectory of the first flyable prop rich in changes as a game battle progresses, improves prop resource utilization of the first flyable prop, enriches interaction manners based on a flyable prop, and improves human-computer interaction efficiency.

In the previous embodiment, the processing logic after collision of flyable props of two different camps is described in detail. In this embodiment of this disclosure, an example in which flyable props of two different camps are launched objects of the two different camps is used for description. A first flyable prop cast by a first virtual object in a first camp is referred to as a first launched object, and a second flyable prop cast by a second virtual object in a second camp is referred to as a second launched object.

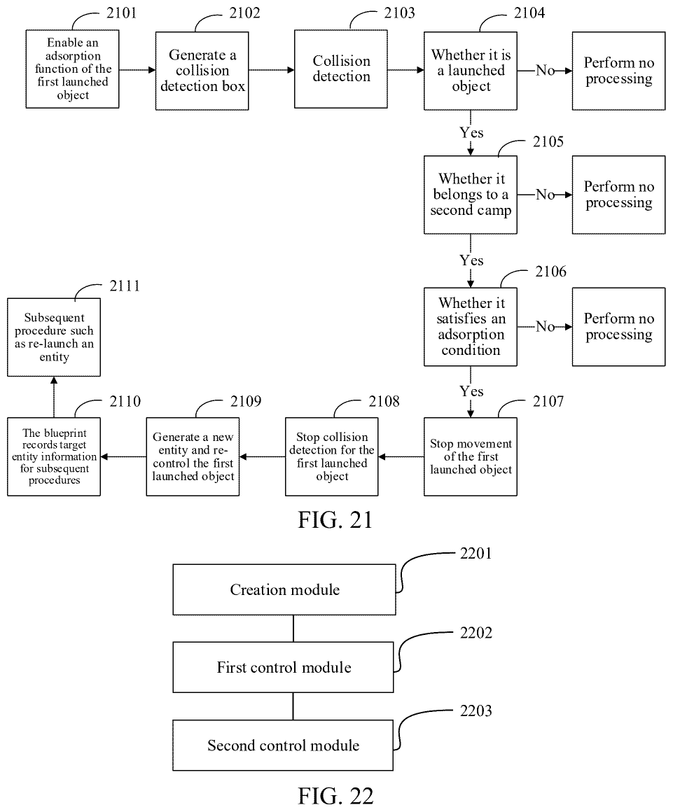

FIG. 21 is a schematic diagram of a principle of an interaction method based on a flyable prop according to an embodiment of this disclosure. The method is performed by an electronic device. Descriptions are made by using an example in which the electronic device is a terminal. This embodiment includes the following operations.

Operation 2101: After a user controls a first virtual object of a first camp to cast a virtual skill, the terminal creates a first launched object of the virtual skill, and enables an adsorption function of the first launched object.

Operation 2102: The terminal generates a collision detection box for the first launched object, to implement a collision detection function.

Operation 2103: The terminal performs real-time collision detection on the first launched object based on the collision detection box.

Operation 2104: When an obstacle is detected in the collision detection box, the terminal determines whether the obstacle is a launched object. If yes, operation 2105 is performed. If no, no processing is performed.

Operation 2105: The terminal determines whether the launched object belongs to a second camp. If yes, operation 2106 is performed. If no, no processing is performed.

Operation 2106: The terminal determines whether the launched object satisfies an adsorption condition. If yes, operation 2107 is performed. If no, no processing is performed.

Operation 2107: The terminal controls the first launched object to stop moving on a first flight trajectory.

Operation 2108: The terminal stops collision detection logic for the first launched object.

Operation 2109: The terminal generates a new entity for the first launched object, and re-controls the first launched object through the new entity.

Operation 2110: The terminal uses a blueprint tool to record the first launched object for subsequent game business procedures.

Operation 2111: The terminal performs the subsequent procedures, for example, re-launches the first launched object on a second flight trajectory and extends effective duration of the first launched object.

According to the technical solution provided in this embodiment of this disclosure, through the collision detection function for the launched object using a virtual skill as a carrier, after a collision between launched objects of two different camps is detected, the launched object of one camp is controlled to be adsorbed by the launched object of the other camp, thereby changing the flight trajectory of the launched object of the other camp and extending the effective duration, which can extend the performance duration of the launched object, enrich the flight trajectory of the launched object, greatly improve the prop resource utilization of the launched object, enrich the interaction manner based on a launched object, and improve the human-computer interaction efficiency.

FIG. 22 is a schematic diagram of a structure of an interaction apparatus based on a flyable prop according to an embodiment of this disclosure. As shown in FIG. 22, the apparatus includes:
a creation module 2201, configured to create a first flyable prop in a virtual scene in response to a cast operation by a first virtual object on a virtual skill, the first flyable prop being associated with the virtual skill, and the first virtual object belonging to a first camp;
a first control module 2202, configured to control the first flyable prop to move along a first flight trajectory, the first flight trajectory being a trajectory determined based on the cast operation; and
a second control module 2203, configured to control, when a second flyable prop is detected within a target range of the first flyable prop, the first flyable prop to move along a second flight trajectory, the second flyable prop being cast by a second virtual object, and the second virtual object belonging to a second camp.

In the technical solution provided in this embodiment of this disclosure, when the second flyable prop is detected within the target range of the first flyable prop, since camps of the first flyable prop and the second flyable prop are different, the first flyable prop is controlled to switch from the first flight trajectory to the second flight trajectory. This makes the flight trajectory of the first flyable prop rich in changes as a game battle progresses, improves prop resource utilization of the first flyable prop, enriches interaction manners based on a flyable prop, and improves human-computer interaction efficiency.

In some embodiments, based on the apparatus composition of FIG. 22, the apparatus further includes a detection module, configured to:
obtain, when an obstacle is detected within the target range of the first flyable prop, a type of the obstacle;
obtain, when the type is a flyable prop, a camp to which the flyable prop belongs; and
determine, when the camp is the second camp and the flyable prop satisfies an adsorption condition, the obstacle as the second flyable prop, the adsorption condition indicating that the flyable prop is able to change a flight trajectory of another flyable prop.

In some embodiments, based on the apparatus composition of FIG. 22, the second control module 2203 includes:
a first control unit, configured to control the first flyable prop to stop moving on the first flight trajectory;
a generation unit, configured to generate the second flight trajectory for the first flyable prop; and
a second control unit, configured to control the first flyable prop to move along the second flight trajectory.

In some embodiments, the generation unit is configured to:
create a second entity carrying a second special effect for the first flyable prop, where the second entity inherits a first entity of the first flyable prop, and the second special effect inherits a first special effect carried by the first entity; and
create the second flight trajectory of the second entity based on a collision position of the first flyable prop and the second flyable prop.

In some embodiments, the generation unit is further configured to:
notify a trajectory change event of the first flyable prop to a flyable prop management array, and add the first flyable prop to the flyable prop management array, where the flyable prop management array is configured for managing a flyable prop whose flight trajectory has been changed in the virtual scene.

In some embodiments, based on the apparatus composition of FIG. 22, the apparatus further includes:
an extension module, configured to extend effective duration of the first flyable prop when the second flyable prop is detected within the target range of the first flyable prop.

In some embodiments, the first flight trajectory is a straight trajectory, and the second flight trajectory is an annular trajectory that encloses the first virtual object.

In some embodiments, based on the apparatus composition of FIG. 22, the apparatus further includes:
a change module, configured to change a form of the first flyable prop based on the second flyable prop, where the form includes at least one of a physical shape or a flying special effect of the first flyable prop; and
the second control module 2203 is further configured to control the first flyable prop whose form has been changed to move along the second flight trajectory. In some embodiments, the change module is configured to:
retain the physical shape of the first flyable prop, and assigning a flying special effect of the second flyable prop to the first flyable prop; or
retain the flying special effect of the first flyable prop, and assigning a physical shape of the second flyable prop to the first flyable prop; or
determine a target form based on the form of the first flyable prop and a form of the second flyable prop, and assign the target form to the first flyable prop.

In some embodiments, the second control module 2203 is configured to:
control, when the second flyable prop is detected within the target range of the first flyable prop, the first flyable prop to move along the second flight trajectory, and cancel display of the second flyable prop.

Any combination of all the foregoing technical solutions can be used to form embodiments of the present disclosure. Details are not described herein again.

When the interaction apparatus based on a flyable prop provided in the foregoing embodiments performs interaction based on a flyable prop, description is made only through examples of division of the functional modules. In an example, the functions may be assigned according to needs to be implemented by different functional modules, that is, the internal structure of the electronic device is divided into different functional modules, so as to implement all or a part of the functions described above. In addition, the embodiments of the interaction apparatus based on a flyable prop and the interaction method based on a flyable prop provided in the foregoing embodiments belong to the same conception. For the specific implementation process, reference may be made to the embodiments of the interaction method based on a flyable prop, and details are not described herein again.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

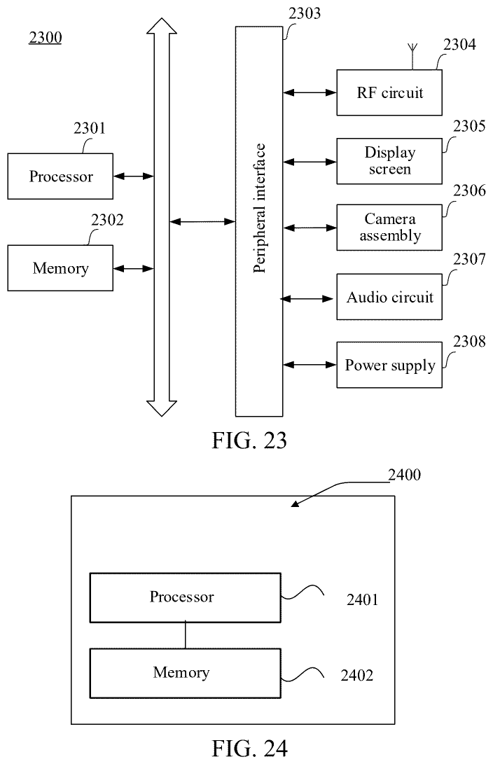

FIG. 23 is a schematic diagram of a structure of a terminal according to an embodiment of this disclosure. As shown in FIG. 23, the terminal 2300 is an example description of an electronic device. In one embodiment, the device types of the terminal 2300 include: a smartphone, a tablet computer, a moving picture experts group audio layer III (MP3) player, a moving picture experts group audio layer IV (MP4) player, a notebook computer, or a desktop computer. The terminal 2300 may also be referred to as another name such as user equipment, a portable terminal, a laptop terminal, or a desktop terminal. Generally, the terminal 2300 includes: a processor 2301 and a memory 2302.

Processing circuitry, such as the processor 2301 may include one or more processing cores, for example, may be a 4-core processor or an 8-core processor. In one embodiment, the processor 2301 may be implemented in at least one hardware form of a digital signal processor (DSP), a field-programmable gate array (FPGA), and a programmable logic array (PLA). In some embodiments, the processor 2301 includes a main processor and a coprocessor. The main processor is configured to process data in an active state, also referred to as a central processing unit (CPU). the coprocessor is a low-power processor configured to process data in a standby state. In some embodiments, the processor 2301 may be integrated with a graphics processing unit (GPU). The GPU is configured to render and draw content that needs to be displayed on a display screen. In some embodiments, the processor 2301 further includes an AI processor. The AI processor is configured to process a computing operation related to machine learning.

In some embodiments, the memory 2302, such as a non-transitory computer-readable storage medium, includes one or more computer-readable storage media. In one embodiment, the computer-readable storage medium is non-transient. In one embodiment, the memory 2302 further includes a high-speed random access memory and a non-volatile memory, such as one or more magnetic disk storage devices or flash storage devices. In some embodiments, a non-transient computer-readable storage medium in the memory 2302 is configured to store at least one piece of program code, and the at least one piece of program code is configured to be executed by the processor 2301 to implement the interaction method based on a flyable prop provided in the embodiments of this disclosure.

In some embodiments, the terminal 2300 may include a peripheral interface 2303 and at least one peripheral. The processor 2301, the memory 2302, and the peripheral interface 2303 may be connected by a bus or a signal cable. Each peripheral may be connected to the peripheral interface 2303 by a bus, a signal cable, or a circuit board. Specifically, the peripheral includes at least one of a radio frequency (RF) circuit 2304, a display screen 2305, a camera assembly 2306, an audio circuit 2307, and a power supply 2308.

The peripheral interface 2303 may be configured to connect the at least one peripheral related to input/output (I/O) to the processor 2301 and the memory 2302. In some embodiments, the processor 2301, the memory 2302, and the peripheral interface 2303 are integrated on the same chip or the same circuit board. In some other embodiments, any one or two of the processor 2301, the memory 2302, and the peripheral interface 2303 may be implemented on an independent chip or circuit board.

The radio frequency circuit 2304 is configured to receive and transmit a radio frequency (RF) signal that is also referred to as an electromagnetic signal. The RF circuit 2304 communicates with a communication network and other communication devices through the electromagnetic signal. The RF circuit 2304 converts an electric signal into an electromagnetic signal for transmission, or converts a received electromagnetic signal into an electric signal. In one embodiment, the RF circuit 2304 includes: an antenna system, an RF transceiver, one or more amplifiers, a tuner, an oscillator, a digital signal processor, a codec chip set, a subscriber identity module card, and the like.

The display screen 2305 is configured to display a UI. In one embodiment, the UI may include a graph, a text, an icon, a video, and any combination thereof. When the display screen 2305 is a touch display screen, the display screen 2305 is further capable of collecting touch signals on or above a surface of the display screen 2305. The touch signal may be inputted to the processor 2301 for processing as a control signal.

The camera component 2306 is configured to capture images or videos. In one embodiment, the camera component 2306 includes a front-facing camera and a rear-facing camera. Generally, the front-facing camera is disposed on the front panel of the terminal, and the rear-facing camera is disposed on a back surface of the terminal. In some embodiments, there are at least two rear cameras, which are respectively any of a main camera, a depth-of-field camera, a wide-angle camera, and a telephoto camera, to implement background blur through fusion of the main camera and the depth-of-field camera, panoramic photographing and virtual reality (VR) photographing through fusion of the main camera and the wide-angle camera, or other fusion photographing functions.

In some embodiments, the audio circuit 2307 may include a microphone and a speaker. The microphone is configured to collect sound waves of users and surroundings, and convert the sound waves into electrical signals and input the signals to the processor 2301 for processing, or input the signals to the RF circuit 2304 to implement voice communication. For the purpose of stereo acquisition or noise reduction, there are a plurality of microphones, disposed at different parts of the terminal 2300 respectively.

The power supply 2308 is configured to supply power to components in the terminal 2300. In one embodiment, the power supply 2308 is an alternating current, a direct current, a disposable battery, or a rechargeable battery. When the power supply 2308 includes a rechargeable battery, the rechargeable battery supports wired charging or wireless charging. The rechargeable battery is further configured to support a fast charge technology.

A person skilled in the art can understand that the structure shown in FIG. 23 does not constitute a limitation to the terminal 2300, and the terminal may include more or fewer components than those shown in the figure, or some components may be combined, or a different component arrangement may be used.

FIG. 24 is a schematic structural diagram of an electronic device according to an embodiment of this disclosure. The electronic device 2400 may vary a lot due to different configurations or performance. The electronic device 2400 includes one or more central processing units (CPUs) 2401 and one or more memories 2402. The memory 2402 stores at least one computer program, the at least one computer program being loaded and executed by the one or more processors 2401 to implement the interaction method based on a flyable prop provided in the foregoing embodiments. In one embodiment, the electronic device 2400 further includes components such as a wired or wireless network interface, a keyboard, and an input/output (I/O) interface, to facilitate input and output. The electronic device 2400 further includes another component configured to implement a function of a device. Details are not further described herein.

In an example, a computer-readable storage medium, for example, a memory including at least one computer program is further provided. The at least one computer program may be executed by a processor in an electronic device to implement the interaction method based on a flyable prop in the foregoing embodiments. For example, the computer-readable storage medium includes a read-only memory (ROM), a random access memory (RAM), a compact disc read-only memory (CD-ROM), a magnetic tape, a floppy disk, an optical data storage device, or the like.

In an example, a computer program product is further provided, including one or more computer programs, the one or more computer programs being stored in a computer-readable storage medium. One or more processors of an electronic device can read the one or more computer programs from the computer-readable storage medium, and the one or more processors execute the one or more computer programs to enable the electronic device to perform the interaction method based on a flyable prop in the foregoing embodiments.

A person of ordinary skill in the art may understand that all or some of the operations of the foregoing embodiments may be implemented by hardware or may be implemented by a program instructing relevant hardware. In one embodiment, the program is stored in a computer-readable storage medium. In one embodiment, the storage medium mentioned above is a ROM, a magnetic disk, an optical disc, or the like.

The foregoing descriptions are merely examples, but are not intended to limit this application. Any modification, equivalent replacement, or improvement made within the spirit and principle of this disclosure shall fall within the protection scope of this disclosure.

What is claimed is:

1. An interaction method, the method comprising:
generating, by processing circuitry, a first flyable prop in a virtual scene when a first cast operation is triggered by a first virtual object, wherein the first flyable prop is associated with a virtual skill and the first virtual object is associated with a first camp;
displaying the first flyable prop that is controlled to move along a first flight trajectory, the first flight trajectory being determined based on the first cast operation; and
controlling the first flyable prop to move along a second flight trajectory when a second flyable prop is detected within a target range of the first flyable prop, wherein
the second flyable prop is generated based on a second cast operation performed by a second virtual object,
the second virtual object is associated with a second camp, and
the second flight trajectory is different from the first flight trajectory.

2. The method according to claim 1, wherein when the second flyable prop is detected within the target range, the method further comprises:
determining whether to change the first flyable prop from the first flight trajectory to the second flight trajectory; and
when the first flyable prop satisfies an adsorption condition, changing the first flyable prop to the second flyable prop.

3. The method according to claim 1, wherein the controlling the first flyable prop to move along with the second flight trajectory comprises:
generating the second flight trajectory for the first flyable prop; and
controlling the first flyable prop to move along the second flight trajectory.

4. The method according to claim 3, wherein the generating the second flight trajectory for the first flyable prop comprises:
generating a second entity carrying a second special effect for the first flyable prop, wherein the second entity includes a first entity of the first flyable prop from the first flight trajectory and the second special effect includes a first special effect carried by the first entity; and
generating the second flight trajectory of the second entity based on a collision position of the first flyable prop and the second flyable prop.

5. The method according to claim 4, wherein the method further comprises:
providing a trajectory change event of the first flyable prop to a flyable prop management array, and
adding the changed first flyable prop to the flyable prop management array, wherein the flyable prop management array is configured to manage flight trajectory changes in the virtual scene.

6. The method according to claim 1, wherein the method further comprises:
extending an effective duration of the first flyable prop when the second flyable prop is detected within the target range of the first flyable prop.

7. The method according to claim 1, wherein the first flight trajectory is a straight trajectory, and the second flight trajectory is an annular trajectory that encloses the first virtual object.

8. The method according to claim 1, wherein the controlling the first flyable prop to move along the second flight trajectory comprises:
updating a display form of the first flyable prop based on the second flyable prop, wherein the display form comprises at least one of a physical shape or a flying special effect of the first flyable prop; and
controlling the first flyable prop with the updated display form to move along the second flight trajectory.

9. The method according to claim 8, wherein the updating the display form of the first flyable prop comprises:
retaining the physical shape of the first flyable prop, and assigning a flying special effect of the second flyable prop to the first flyable prop;
retaining the flying special effect of the first flyable prop, and assigning a physical shape of the second flyable prop to the first flyable prop; or
determining a target display form based on the display form of the first flyable prop and a display form of the second flyable prop, and assigning the target display form to the first flyable prop.

10. The method according to claim 1, wherein the controlling the first flyable prop to move along the second flight trajectory comprises:
canceling the display of the second flyable prop when the first flyable prop movies along the second flight trajectory.

11. An apparatus, t comprising:
processing circuitry configured to:
generate a first flyable prop in a virtual scene when a first cast operation is triggered by a first virtual object, wherein the first flyable prop is associated with a virtual skill and the first virtual object is associated with a first camp;
display the first flyable prop that is controlled to move along a first flight trajectory, the first flight trajectory is determined based on the first cast operation; and
control the first flyable prop to move along a second flight trajectory when a second flyable prop is detected within a target range of the first flyable prop, wherein
the second flyable prop is generated based on a second cast operation performed by a second virtual object,
the second virtual object is associated with a second camp, and
the second flight trajectory is different from the first flight trajectory.

12. The apparatus according to claim 11, wherein the processing circuitry is configured to:
determine whether to change the first flyable prop from the first flight trajectory to the second flight trajectory; and
when the first flyable prop satisfies an adsorption condition, change the first flyable prop to the second flyable prop.

13. The apparatus according to claim 11, wherein the processing circuitry is configured to:
generate the second flight trajectory for the first flyable prop; and
control the first flyable prop to move along the second flight trajectory.

14. The apparatus according to claim 13, wherein the processing circuitry is configured to:
generate a second entity that carries a second special effect for the first flyable prop, wherein the second entity includes a first entity of the first flyable prop from the first flight trajectory and the second special effect includes a first special effect carried by the first entity; and
generate the second flight trajectory of the second entity based on a collision position of the first flyable prop and the second flyable prop.

15. The apparatus according to claim 14, wherein the processing circuitry is configured to:
provide a trajectory change event of the first flyable prop to a flyable prop management array, and
add the changed first flyable prop to the flyable prop management array, wherein the flyable prop management array is configured to manage flight trajectory changes in the virtual scene.

16. A non-transitory computer-readable storage medium, storing instructions which when executed by a processor cause the processor to perform:
generating a first flyable prop in a virtual scene when a first cast operation is triggered by a first virtual object, wherein the first flyable prop is associated with a virtual skill and the first virtual object is associated with a first camp;
displaying the first flyable prop that is controlled to move along a first flight trajectory, the first flight trajectory being determined based on the first cast operation; and
controlling the first flyable prop to move along a second flight trajectory when a second flyable prop is detected within a target range of the first flyable prop, wherein
the second flyable prop is generated based on a second cast operation performed by a second virtual object, the second virtual object is associated with a second camp, and
the second flight trajectory is different from the first flight trajectory.

17. The non-transitory computer-readable storage medium according to claim 16, wherein the instructions when executed by the processor further cause the processor to perform:
determining whether to change the first flyable prop from the first flight trajectory to the second flight trajectory; and
when the first flyable prop satisfies an adsorption condition, changing the first flyable prop to the second flyable prop.

18. The non-transitory computer-readable storage medium according to claim 16, wherein the instructions when executed by the processor further cause the processor to perform:
generating the second flight trajectory for the first flyable prop; and
controlling the first flyable prop to move along the second flight trajectory.

19. The non-transitory computer-readable storage medium according to claim 18, wherein the instructions when executed by the processor further cause the processor to perform:
generating a second entity carrying a second special effect for the first flyable prop, wherein the second entity includes a first entity of the first flyable prop from the first flight trajectory and the second special effect includes a first special effect carried by the first entity; and
generating the second flight trajectory of the second entity based on a collision position of the first flyable prop and the second flyable prop.

20. The non-transitory computer-readable storage medium according to claim 19, wherein the instructions when executed by the processor further cause the processor to perform:
providing a trajectory change event of the first flyable prop to a flyable prop management array, and
adding the changed first flyable prop to the flyable prop management array, wherein the flyable prop management array is configured to manage flight trajectory changes in the virtual scene.
